(19) United States
(12) Patent Application Publication
(10) Pub. No.: US 2024/0080156 A1
(43) Pub. Date: Mar. 7, 2024

(54) PT-RS FOR PUSCH TRANSMISSIONS TO MULTIPLE TRPs

(71) Applicant: Telefonaktiebolaget LM Ericsson (publ), Stockholm (SE)

(72) Inventors: Shiwei Gao, Nepean (CA); Mattias Frenne, Uppsala (SE); Jianwei Zhang, Solna (SE); Siva Muruganathan, Stittsville (CA)

(21) Appl. No.: 18/552,843

(22) PCT Filed: Apr. 4, 2022
(86) PCT No.: PCT/IB2022/053119

§ 371 Date: Sep. 27, 2023

Related U.S. Application Data
(60) Provisional application No. 63/170,023, filed on Apr. 2, 2021.

(51) Int. Cl. H04L 5/00; H04W 72/232

(52) U.S. Cl. CPC H04L 5/0048; H04L 5/0035; H04W 72/232

(57) ABSTRACT

In one embodiment, a method performed by a wireless device comprises receiving Downlink Control Information (DCI) that schedules Physical Uplink Shared Channel (PUSCH) repetitions to Transmission/Reception Points (TRPs) where the PUSCH is configured with a maximum rank larger than 2. The DCI comprises an antenna ports field that indicates two or more Demodulation Reference Signal (DMRS) ports and either: a single PTRS-DMRS association field or two PTRS-DMRS association fields. The method further comprises determining a DMRS port associated with a Phase Tracking Reference Signal (PTRS) port for PUSCH transmissions to a first TRP based on either a most significant bit (MSB) of the single PTRS-DMRS association field or the first PTRS-DMRS association field and determining a DMRS port associated with a PTRS port for PUSCH transmissions to a second TRP based on either a least significant bit (LSB) of the single PTRS-DMRS association field or the second PTRS-DMRS association field.

### RELATED APPLICATIONS

This application claims the benefit of provisional patent application Ser. No. 63/170,023, filed Apr. 2, 2021, the disclosure of which is hereby incorporated herein by reference in its entirety.

### TECHNICAL FIELD

The present disclosure relates to a cellular communications system such as, e.g., a Third Generation Partnership Project (3GPP) Fifth Generation System (5GS) and, more specifically, to Phase Tracking Reference Signal (PT-RS) for Physical Uplink Shared Channel (PUSCH) transmissions.

### BACKGROUND

### 1 New Radio (NR) Frame Structure and Resource Grid

Third Generation Partnership Project (3GPP) New Radio (NR) uses Cyclic Prefix Orthogonal Frequency Division Multiplexing (CP-OFDM) in both downlink (i.e., from a network node, gNB, or base station, to a user equipment or UE) and uplink (i.e., from UE to gNB). Discrete Fourier Transform (DFT) spread Orthogonal Frequency Division Multiplexing (OFDM) is also supported in the uplink. In the time domain, NR downlink and uplink are organized into equally-sized subframes of 1 millisecond (ms) each. A subframe is further divided into multiple slots of equal duration. The slot length depends on subcarrier spacing. For subcarrier spacing of Δf=15 kilohertz (kHz), there is only one slot per subframe and each slot consists of 14 OFDM symbols. FIG. 1 illustrates the NR time-domain structure with 15 kHz subcarrier spacing.

Data scheduling in NR is typically in slot basis, an example is shown in FIG. 1 with a 14-symbol slot, where the first two symbols contain Physical Downlink Control Channel (PDCCH) and the rest contains physical shared data channel, either Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15×2^{μ}) kHz where μ∈0,1,2,3,4·Δf=15 kHz is the basic subcarrier spacing. The slot durations at different subcarrier spacings is given by

$$\frac{1}{{2}^{μ}} ms .$$

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in FIG. 2, where only one RB within a 14-symbol slot is shown. One OFDM subcarrier during one OFDM symbol interval forms one resource element (RE).

Uplink (UL) transmissions can be dynamically scheduled by an uplink grant in downlink control information (DCI) carried by Physical Downlink Control Channel (PDCCH).

### 2 PUSCH Transmission Schemes

In NR, there are two transmission schemes specified for PUSCH, codebook based and non-codebook based.

### 2.1 Codebook Based PUSCH

Codebook based PUSCH is enabled if higher layer parameter txConfig=codebook. For dynamically scheduled PUSCH and configured grant PUSCH type 2, the codebook based PUSCH transmission scheme can be summarized as follows:
The UE transmits Sounding Reference Signal (SRS) configured in an SRS resource set with a higher layer parameter usage set to ‘CodeBook’. Note that only a single SRS resource set can be configured with usage set to “codebook”. Up to two SRS resources, each with up to four antenna ports can be configured in the SRS resource set.
The gNB determines a number of layers (or rank) and a preferred precoder (i.e., Transmit Precoding Matrix Indicator (TPMI)) from a codebook subset based on the received SRS from one of the SRS resource(s).
The gNB indicates the selected SRS resource via a 1-bit ‘SRS resource indicator’ (SRI) field in a DCI scheduling the PUSCH if two SRS resources are configured in the SRS resource set. The ‘SRS resource indicator’ field is not present in DCI if only one SRS resource is configured in the SRS resource set.
The gNB also indicates the preferred TPMI and the associated number of layers of the PUSCH associated with the indicated SRS resource.
The UE performs PUSCH transmission using the TPMI and the number of layers indicated over the SRS antenna ports.
Demodulation Reference Signal (DMRS) port(s) associated with the layer(s) are indicated in an “Antenna ports” field in the DCI together with a number of Code Division Multiplexing (CDM) groups without data.

The codebook subset can be one of:
fullyAndPartialAndNonCoherent
partialAndNonCoherent
non-coherent
   and is configured based on UE reported capability.

Note that in NR, an antenna port is defined such that the channel over which a symbol on the antenna port is conveyed can be inferred from the channel over which another symbol on the same antenna port is conveyed. In the uplink, DMRS antenna ports for PUSCH starts with 0 and SRS, PUSCH antenna ports starting with 1000.

### 2.2 Non-Codebook Based PUSCH

Non-Codebook based PUSCH transmission is for reciprocity-based UL transmission in which SRS precoding is derived at a UE based on a configured downlink (DL) Channel State Information Reference Signal (CSI-RS). From the DL CSI-RS, the UE can measure and deduce suitable precoder weights for SRS transmission, resulting in one or more (virtual) SRS ports, each corresponding to a spatial layer. A UE can be configured up to four SRS resources, each with a single (virtual) SRS port, in an SRS resource set. A UE can transmit SRS in the up to four SRS resources, and the gNB measures UL channel based on the received SRS and determines the preferred SRS resource(s). Subsequently, the gNB indicates the selected SRS resources via an SRS resource indicator (SRI). Note that only a single SRS resource set can be configured with usage set to “non-codebook”.

### 3 Demodulation Reference Signal (DMRS or DM-RS) for PUSCH

DMRS is used for PUSCH demodulation purpose. DMRS is confined to resource blocks allocated to PUSCH.

The mapping of DMRS to resource elements is configurable in both frequency and time domain. In the frequency domain, there are two mapping types, i.e., Type 1 or Type 2, which is configured by a higher layer parameter dmrs-Type in DMRS-UplinkConfig.

The DMRS mapping in time domain can be either single-symbol based or double-symbol based, where the latter means that DMRS is mapped in pairs of two adjacent symbols. Furthermore, a UE can be configured with one, two, three, or four single-symbol DM-RS and one or two double-symbol DMRS.

FIG. 3 shows an example of Type 1 and Type 2 DMRS with single-symbol DMRS. Type 1 and Type 2 differs with respect to both the mapping structure and the number of supported DMRS CDM groups, where Type 1 support 2 CDM groups while Type 2 support 3 CDM groups.

A DMRS antenna port is mapped to the resource elements within one CDM group only. For single-symbol DMRS, two antenna ports can be mapped to each CDM group.

### 4 Phase-Tracking Reference Signals (PTRS or PT-RS) for PUSCH in NR

In NR, Phase Tracking Reference Signal (PT-RS) can be configured for PUSCH transmissions in order for the receiver to correct phase noise related errors. PT-RS can be configured with the higher layer parameter PTRS-UplinkConfig in DMRS-UplinkConfig for PUSCH scheduled by DCI format 0_1 or DCI format 0_2.

In NR Release 15, for CP-OFDM based waveform, either one or two PT-RS ports for PUSCH are supported. Each PT-RS port is associated with one of the DMRS ports for the PUSCH.

If more than one DMRS port is scheduled, i.e., multi-layer MIMO transmission of PUSCH, then it is desirable from the performance perspective if the PT-RS is transmitted in a layer having the highest Signal to Interference plus Noise Ratio (SINR). This will maximize the phase tracking performance. The network knows which layer has the best SINR based on measurements on the multi-port SRS. Hence, the network can, when scheduling the PUSCH from the UE, indicate which layer the UE is to transmit the PT-RS on. This is signaled using PTRS-DMRS association, as defined by the table below.

The maximum number of configured PT-RS ports is given by the higher layer parameter maxNrofPorts in PTRS-UplinkConfig based on the UE reported need. If a UE has reported the capability of supporting full-coherent UL transmission, one PT-RS port is expected to be configured if needed.

In the frequency domain, for CP-OFDM based waveform, a PT-RS can be in at most one subcarrier every 2 PRBs. Also, the subcarrier used for a PT-RS port must be one of the subcarriers also used for the DMRS port associated with the PT-RS port. For DMRS configuration type 1, a DM-RS port is mapped to every second subcarrier. Consequently, an associated PT-RS can only be mapped to one out of 6 subcarriers in a PRB. An offset can be configured to determine which subcarrier the DM-RS is mapped to (see Table 6.4.1.2.2.1-1 in 3GPP TS 38.211 v16.4.0).

In the time domain, a PT-RS can be configured with a time density of 1, 2, or 4, corresponding to PT-RS in every OFDM symbol, every second OFDM symbols, or every fourth OFDM symbols in a slot, respectively. The modulated symbol used for the PT-RS is the same as the associated DM-RS at the same subcarrier.

A PT-RS example, for CP-OFDM based waveform, is shown in FIG. 4, where the PT-RS port is associated with DM-RS port 0 and has a subcarrier offset of 4 and a time density of 2.

For codebook or non-codebook based UL transmission, the association between UL PT-RS port(s) and DM-RS port(s) is signaled by a “PTRS-DMRS association” field in DCI format 0_1 and DCI format 0_2.

If the UE is configured with one PT-RS port, the DM-RS port associated with the PT-RS port is indicated by DCI parameter “PTRS-DMRS association” in DCI format 0_1 and DCI format 0_2 in Table 7.3.1.1.2-25 of 3gpp TS 38.212, which is reproduced below. As discussed above the purpose is to schedule the PT-RS to be transmitted on the strongest layer/DMRS port (since there is one DMRS port per layer).

TABLE 7.3.1.1.2-25
PTRS-DMRS association for UL PTRS port 0

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

For non-codebook based UL transmission, the actual number of PT-RS port(s) to transmit is determined based on SRI(s) in DCI format 0_1 and DCI format 0_2. A UE is configured with the PT-RS port index for each configured SRS resource by the higher layer parameter ptrs-PortIndex configured by SRS-Config. If the PT-RS port index associated with different SRIs are the same, the corresponding UL DM-RS ports are associated to the same PT-RS port.

For partial-coherent and non-coherent codebook based UL transmission, the actual number of UL PT-RS port(s) is determined based on TPMI and/or number of layers which are indicated by ‘Precoding information and number of layers’ field in DCI format 0_1 and DCI format 0_2. If the UE is configured with 2 PT-RS ports, the actual PT-RS port(s) and the associated transmission layer(s) are derived from indicated TPMI as:
PUSCH antenna port 1000 and 1002 in indicated TPMI share PT-RS port 0, and PUSCH antenna port 1001 and 1003 in indicated TPMI share PT-RS port 1.
PT-RS port 0 is associated with a DM-RS port which are transmitted with PUSCH antenna port 1000 and PUSCH antenna port 1002 in indicated TPMI, and PT-RS port 1 is associated with another DM-RS port which are transmitted with PUSCH antenna port 1001 and PUSCH antenna port 1003 in indicated TPMI, where the two DM-RS ports are given by DCI parameter ‘PTRS-DMRS association’ in DCI format 0_1 and DCI format 0_2 in Table 7.3.1.1.2-26 of 3gpp TS 38.212, which is reproduced below.

TABLE 7.3.1.1.2-26
PTRS-DMRS association for UL PTRS ports 0 and 1

| Value of | | Value of | |
|---|---|---|---|
| MSB | DMRS port | LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

### 5 NR Release 17 Enhancements for PUSCH Transmission Towards Two TRPs

In NR Release 17, it has been agreed that PUSCH repetition to two transmission and reception points (TRPs) will be supported. For that purpose, two SRS resource sets with usage set to either “codebook” based or “nonCodebook” will be introduced, each SRS resource set is associated with a TRP. PUSCH repetition to two TRPs can be scheduled by a DCI with two SRS resource indicator (SRI) fields, where a first SRI field is associated with a first SRS resource set and a second SRI field is associated with a second SRS resource set.

An example is shown in FIG. 5, where a PUSCH repetition towards two TRPs is scheduled by a DCI indicating two SRI fields.

To support PT-RS to DM-RS association for each TRP, an agreement was made in 3GPP RAN1 #104e meeting to reuse the same 2 bits in “PTRS-DMRS association” field in DCI format 0_1 and DCI format 0_2, with one bit for each TRP.

### “Agreement

For single DCI based M-TRP PUSCH Type B repetition schemes,
For maxRank=2, the number of bits for the indication of PTRS-DMRS association is the same as Rel-15/16, MSB and LSB separately indicating the association between PTRS port and DMRS port for two TRPs.
FFS: the indication of PTRS-DMRS association for maxRank>2.”

### 6 PT-RS Power Boosting

The factor related to PUSCH to PT-RS power ratio per layer per RE is indicated to UE by power boosting factor ptrs-Power in PTRS-UplinkConfig IE via higher layer configuration.

The UL PTRS power boosting factor per PTRS port is defined in 3GPP TS 38.214 v16.4.0 table 6.2.3.1-3 that is reproduced below:

TABLE 6.2.3.1-3:
Factor related to PUSCH to PT-RS power ratio per layer per REα_{PTRS}^{PUSCH}

| | The number of PUSCH layers (n_{layer}^{PUSCH}) | | | | | | | |
|---|---|---|---|---|---|---|---|---|
| | | 2 | | 3 | | | | |
| | | | Partial and | | Partial and | 4 | | |
| UL-PTRS- | 1 | | non-coherent | | non-coherent | | | Non-coherent |
| power/ | All | Full | and non- | Full | and non- | Full | Partial | and non- |
| α_{PTRS}^{PUSCH} | cases | coherent | codebook based | coherent | codebook based | coherent | coherent | codebook based |
| 00 | 0 | 3 | 3Qₚ − 3 | 4.77 | 3Qₚ − 3 | 6 | 3Qₚ | 3Qₚ − 3 |
| 01 | 0 | 3 | 3 | 4.77 | 4.77 | 6 | 6 | 6 |

| | |
|---|---|
| 10 | Reserved |
| 11 | Reserved |

### SUMMARY

Systems and methods are disclosed that relate to Phase Tracking Reference Signal (PTRS) for Physical Uplink Shared Channel (PUSCH) transmissions to multiple Transmission/Reception Points (TRPs). In one embodiment, a method performed by a wireless communication device comprises receiving Downlink Control Information (DCI) from a base station, wherein the DCI schedules PUSCH repetitions to two TRPs and the PUSCH is configured by the base station with a maximum rank larger than 2. The DCI comprises an antenna ports field that indicates two or more Demodulation Reference Signal (DMRS) ports and either: a single PTRS to DMRS (PTRS-DMRS) association field, the PTRS-DMRS association field being a 2-bit field, or two PTRS-DMRS association fields, a first and a second PTRS-DMRS fields, each having 2 bits. The method further comprises determining at least one DMRS port associated with at least one PTRS port for PUSCH transmissions to a first TRP based on either a value of a most significant bit (MSB) of the single PTRS-DMRS association field or the first PTRS-DMRS association field comprised in the DCI and determining at least one DMRS port associated with at least one PTRS port for PUSCH transmissions to a second TRP based on either a value of a least significant bit, LSB, of the single PTRS-DMRS association field or the second PTRS-DMRS association field comprised in the DCI. The method further comprises transmitting a first PUSCH repetition to the first TRP with the at least one PTRS port for PUSCH transmissions to the first TRP and transmitting a second PUSCH repetition to the second TRP with the at least one PTRS port for PUSCH transmissions to the first TRP, wherein either: the MSB of the single PTRS-DMRS association field or the first PTRS-DMRS association field is associated with the first TRP and the LSB of the single PTRS-DMRS association field or the second PTRS-DMRS association field is associated with the second TRP, where the first TRP is associated with a first Sounding Reference Signal (SRS) Resource Indicator (SRI) field in the DCI and the second TRP is associated with a second SRI field in the DCI; or the MSB of the single PTRS-DMRS association field or the first PTRS-DMRS association field is associated with a first SRS resource set associated to the first TRP and the LSB of the single PTRS-DMRS association field or the second PTRS-DMRS association field is associated with a second SRS resource set associated to the second TRP, where the first SRS resource set is associated with the first SRI field in the DCI and the second SRS resource set is associated with the second SRI field in the DCI; or the MSB of the single PTRS-DMRS association field or the first PTRS-DMRS association field is associated with a first Transmit Precoding Matrix Indictor (TPMI) field of the DCI associated to the first TRP and the LSB of the single PTRS-DMRS association field or the second PTRS-DMRS association field is associated with a second TPMI field of the DCI associated to the second TRP.

In one embodiment, the DCI comprises the single PTRS-DMRS association field, the MSB of the single PTRS-DMRS association field is associated with the first TRP, and the LSB of the single PTRS-DMRS association field is associated with the second TRP, wherein the first TRP is associated with the first SRI field in the DCI and the second TRP is associated with the second SRI field in the DCI.

In one embodiment, the DCI comprises the two PTRS-DMRS association fields, the first and the second PTRS-DMRS fields, each having 2 bits. The first PTRS-DMRS association field is associated with the first TRP, and the second PTRS-DMRS association field is associated with the second TRP, wherein the first TRP is associated with the first SRI field in the DCI and the second TRP is associated with the second SRI field in the DCI.

In one embodiment, the DCI comprises the single PTRS-DMRS association field, the MSB of the single PTRS-DMRS association field is associated with the first SRS resource set associated to the first TRP, and the LSB of the single PTRS-DMRS association field is associated with the second SRS resource set associated to the second TRP, wherein the first SRS resource set is associated with the first SRI field in the DCI and the second SRS resource set is associated with the second SRI field in the DCI.

In one embodiment, the DCI comprises the two PTRS-DMRS association fields, the first and the second PTRS-DMRS fields, each having 2 bits. The first PTRS-DMRS association field is associated with the first SRS resource set associated to the first TRP, and the second PTRS-DMRS association field is associated with the second SRS resource set associated to the second TRP, wherein the first SRS resource set is associated with the first SRI field in the DCI and the second SRS resource set is associated with the second SRI field in the DCI.

In one embodiment, the DCI comprises the single PTRS-DMRS association field, the DCI is for non-codebook based PUSCH transmission and further comprises a first SRI field and a second SRI field, the MSB of the single PTRS-DMRS association field is associated with the first SRI field, and the LSB of the single PTRS-DMRS association field is associated with the second SRI field.

In one embodiment, the DCI comprises the two PTRS-DMRS association fields, the first and the second PTRS-DMRS fields, each having 2 bits. The DCI is for non-codebook based PUSCH transmission and further comprises a first SRI field and a second SRI field, the first PTRS-DMRS association field is associated with the first SRI field, and the second PTRS-DMRS association field is associated with the second SRI field.

In one embodiment, if a value of the MSB is ‘0’ and a single PT-RS port 0 is configured, then PT-RS port 0 for the first TRP is associated with a first DMRS port indicated in the antenna port field of the DCI. If the value of the MSB is ‘1’ and a single PT-RS port 0 is configured, then PT-RS port 0 for the first TRP is associated with a second DMRS port indicated in the antenna port field of the DCI.

In one embodiment, if a value of the LSB is ‘0’ and a single PT-RS port 0 is configured, then PT-RS port 0 for the second TRP is associated with a first DMRS port indicated in the antenna port field of the DCI. If the value of the LSB is ‘1’ and a single PT-RS port 0 is configured, then PT-RS port 0 for the second TRP is associated with a second DMRS port indicated in the antenna port field of the DCI.

In one embodiment, the DCI comprises the single PTRS-DMRS association field, the MSB of the single PTRS-DMRS association field is associated with the first TPMI field of the DCI associated to the first TRP, and the LSB of the single PTRS-DMRS association field is associated with the second TPMI field of the DCI associated to the second TRP.

In one embodiment, the DCI comprises the two PTRS-DMRS association fields, the first and the second PTRS-DMRS fields, each having 2 bits. The first PTRS-DMRS association field is associated with the first TPMI field of the DCI associated to the first TRP, and the second PTRS-DMRS association field is associated with the second TPMI field of the DCI associated to the second TRP.

In one embodiment, the DCI comprises the single PTRS-DMRS association field, the DCI is for codebook based PUSCH transmission and further comprises a first TPMI field and a second TPMI field, the MSB of the single PTRS-DMRS association field is associated with the first TPMI field, and the LSB of the single PTRS-DMRS association field is associated with the second TPMI field.

In one embodiment, the DCI comprises the two PTRS-DMRS association fields, the first and the second PTRS-DMRS fields, each having 2 bits. The DCI is for codebook based PUSCH transmission and further comprises a first TPMI field and a second TPMI field, the first PTRS-DMRS association field is associated with the first TPMI field, and the second PTRS-DMRS association field is associated with the second TPMI field.

In one embodiment, if a value of the MSB is ‘0’ and a single PT-RS port 0 is configured, then PT-RS port 0 for the first TRP is associated with a first DMRS port indicated in the antenna port field of the DCI. If the value of the MSB is ‘1’ and a single PT-RS port 0 is configured, then PT-RS port 0 for the first TRP is associated with a second DMRS port indicated in the antenna port field of the DCI.

In one embodiment, if a value of the LSB is ‘0’ and a single PT-RS port 0 is configured, then PT-RS port 0 for the second TRP is associated with a first DMRS port indicated in the antenna port field of the DCI. If the value of the LSB is ‘1’ and a single PT-RS port 0 is configured, then PT-RS port 0 for the second TRP is associated with a second DMRS port indicated in the antenna port field of the DCI.

In one embodiment, determining the at least one DMRS port associated with the at least one PTRS port for PUSCH transmissions to the first TRP comprises determining a first DMRS port associated with a first PTRS port for PUSCH transmissions to the first TRP based on either the MSB of the single PTRS-DMRS association field or the first PTRS-DMRS association field comprised in the DCI. Determining the at least one DMRS port associated with the at least one PTRS port for PUSCH transmissions to the second TRP comprises determining a second DMRS port associated with a second PTRS port for PUSCH transmissions to the second TRP based on either the LSB of the single PTRS-DMRS association field or the second PTRS-DMRS association field comprised in the DCI. Transmitting the first PUSCH repetition to the first TRP comprises transmitting the first PUSCH repetition to the first TRP with the first PTRS port associated to the first DMRS port, and transmitting the second PUSCH repetition to the second TRP comprises transmitting the second PUSCH repetition to the second TRP with the second PTRS port associated to the second DMRS port.

In one embodiment, a rank 3 or 4 is indicated in the DCI, the MSB of the single PTRS-DMRS association field indicates one of first and third DMRS ports indicated in the antenna ports field to be associated with a first PTRS port for the PUSCH transmissions to the first TRP, and the LSB of the single PTRS-DMRS association field indicates one of the first and third DMRS ports indicated in the antenna ports field to be associated with a second PTRS port for the PUSCH transmissions to the second TRP.

In one embodiment, the first PTRS-DMRS association field indicates one of up to four DMRS ports indicated in the antenna ports field to be associated with a first PTRS port for the PUSCH transmissions to the first TRP, and the second PTRS-DMRS association field indicates one of up to four DMRS ports indicated in the antenna ports field to be associated with a first PTRS port for the PUSCH transmissions to the second TRP.

In one embodiment, the wireless communication device is configured with two PTRS ports per TRP, and determining the at least one DMRS port associated with the at least one PTRS port for PUSCH transmissions to the first TRP comprises determining a first DMRS port associated with a first PTRS port for PUSCH transmissions to the first TRP based on the value of the MSB of the single PTRS-DMRS association field or the first PTRS-DMRS association field comprised in the DCI, and determining a second DMRS port associated with a second PTRS port for PUSCH transmission to the first TRP based on either the value of the MSB of the single PTRS-DMRS association field or the LSB of the first PTRS-DMRS association field comprised in the DCI. Determining the at least one DMRS port associated with the at least one PTRS port for PUSCH transmissions to the second TRP comprises determining a third DMRS port associated with a third PTRS port for PUSCH transmissions to the second TRP based on the value of either the LSB of the single PTRS-DMRS association field or the MSB of the second PTRS-DMRS association field comprised in the DCI and determining a fourth DMRS port associated with a fourth PTRS port for PUSCH transmission to the second TRP based on the value of the LSB of the single PTRS-DMRS association field or the second PTRS-DMRS association field comprised in the DCI. Transmitting the first PUSCH repetition to the first TRP comprises transmitting the first PUSCH repetition to the first TRP with the first PTRS port associated to the first DMRS port and the second PTRS port associated to the second DMRS port, and transmitting the second PUSCH repetition to the second TRP comprises transmitting the second PUSCH repetition to the second TRP with the third PTRS port associated to the third DMRS port and the fourth PTRS port associated to the fourth DMRS port.

In one embodiment, the DCI comprises the single PTRS-DMRS association field, the MSB of the single PTRS-DMRS association field indicates the first DMRS port associated to the first PTRS port from among a first DMRS port group and the second DMRS port associated to the second PTRS port from among a second DMRS port group, and the LSB of the single PTRS-DMRS association field indicates the third DMRS port associated to the third PTRS port from among the first DMRS port group and the fourth DMRS port associated to the fourth PTRS port from among the second DMRS port group.

In one embodiment, the DCI comprises the two PTRS-DMRS association fields, the first and the second PTRS-DMRS fields, each having 2 bits. The MSB of the first PTRS-DMRS association field indicates the first DMRS port associated to the first PTRS port from among a first DMRS port group, the LSB of the first PTRS-DMRS association field indicates the second DMRS port associated to the second PTRS port from among a second DMRS port group, the MSB of the second PTRS-DMRS association field indicates the third DMRS port associated to the third PTRS port from among the first DMRS port group, and the LSB of the second PTRS-DMRS association field indicates the fourth DMRS port associated to the fourth PTRS port from among the second DMRS port group.

In one embodiment, the first DMRS port is associated to a first PUSCH or SRS port group sharing PT-RS port 0, and the second DMRS port is associated to a second PUSCH or SRS port group sharing PT-RS port 1.

Corresponding embodiments of a wireless communication device are also disclosed. In one embodiment, a wireless communication device is adapted to receive DCI from a base station, wherein the DCI schedules PUSCH repetitions to two TRPs and the PUSCH is configured by the base station with a maximum rank larger than 2. The DCI comprises an antenna ports field that indicates two or more DMRS ports and either: a single PTRS-DMRS association field, the PTRS-DMRS association field being a 2-bit field, or two PTRS-DMRS association fields, a first and a second PTRS-DMRS fields, each having 2 bits. The wireless communication device is further adapted to determine at least one DMRS port associated with at least one PTRS port for PUSCH transmissions to a first TRP based on either a value of a MSB of the single PTRS-DMRS association field or the first PTRS-DMRS association field comprised in the DCI and determine at least one DMRS port associated with at least one PTRS port for PUSCH transmissions to a second TRP based on either a value of a LSB of the single PTRS-DMRS association field or the second PTRS-DMRS association field comprised in the DCI. The wireless communication device is further adapted to transmit a first PUSCH repetition to the first TRP with the at least one PTRS port for PUSCH transmissions to the first TRP and transmit a second PUSCH repetition to the second TRP with the at least one PTRS port for PUSCH transmissions to the first TRP, wherein either: the MSB of the single PTRS-DMRS association field or the first PTRS-DMRS association field is associated with the first TRP and the LSB of the single PTRS-DMRS association field or the second PTRS-DMRS association field is associated with the second TRP, where the first TRP is associated with a first SRI field in the DCI and the second TRP is associated with a second SRI field in the DCI; or the MSB of the single PTRS-DMRS association field or the first PTRS-DMRS association field is associated with a first SRS resource set associated to the first TRP and the LSB of the single PTRS-DMRS association field or the second PTRS-DMRS association field is associated with a second SRS resource set associated to the second TRP, where the first SRS resource set is associated with the first SRI field in the DCI and the second SRS resource set is associated with the second SRI field in the DCI; or the MSB of the single PTRS-DMRS association field or the first PTRS-DMRS association field is associated with a first TPMI field of the DCI associated to the first TRP and the LSB of the single PTRS-DMRS association field or the second PTRS-DMRS association field is associated with a second TPMI field of the DCI associated to the second TRP.

In another embodiment, a method performed by a wireless communication device comprises receiving DCI from a base station, wherein the DCI schedules PUSCH repetitions to two TRPs and the DCI comprises an antenna ports field that indicates two or more DMRS ports and a PTRS-DMRS association field, the PTRS-DMRS association field being a 2-bit field. The method further comprises determining at least one DMRS port associated with at least one PTRS port for PUSCH transmissions to a first TRP based on a value of a MSB of the PTRS-DMRS association field comprised in the DCI and determining at least one DMRS port associated with at least one PTRS port for PUSCH transmissions to a second TRP based on a value of a LSB of the PTRS-DMRS association field comprised in the DCI. The method further comprises transmitting a first PUSCH repetition to the first TRP with the at least one PTRS port for PUSCH transmissions to the first TRP and transmitting a second PUSCH repetition to the second TRP with the at least one PTRS port for PUSCH transmissions to the first TRP, wherein either: the MSB of the PTRS-DMRS association field is associated with the first TRP and the LSB of the PTRS-DMRS association field is associated with the second TRP, where the first TRP is associated with a first SRI field in the DCI and the second TRP is associated with a second SRI field in the DCI; or the MSB of the PTRS-DMRS association field is associated with a first SRS resource set associated to the first TRP and the LSB of the PTRS-DMRS association field is associated with a second SRS resource set associated to the second TRP, where the first SRS resource set is associated with the first SRI field in the DCI and the second SRS resource set is associated with the second SRI field in the DCI; or the MSB of the PTRS-DMRS association field is associated with a first Transmit Precoding Matrix Indictor, TPMI, field of the DCI associated to the first TRP and the LSB of the PTRS-DMRS association field is associated with a second TPMI field of the DCI associated to the second TRP.

In another embodiment, a method performed by a wireless communication device comprises receiving DCI from a base station, wherein the DCI schedules PUSCH repetitions to two TRPs and the DCI comprises an antenna ports field that indicates two or more DMRS ports and a first PTRS-DMRS association field and a second PTRS-DMRS association field, each being a 2-bit field. The method further comprises determining at least one DMRS port associated with at least one PTRS port for PUSCH transmissions to a first TRP based on a value of at least one PTRS-DMRS association field comprised in the DCI, and determining at least one DMRS port associated with at least one PTRS port for PUSCH transmissions to a second TRP based on the value of the at least one PTRS-DMRS association field comprised in the DCI. The method further comprises transmitting a first PUSCH repetition to the first TRP with the at least one PTRS port for PUSCH transmissions to the first TRP and transmitting a second PUSCH repetition to the second TRP with the at least one PTRS port for PUSCH transmissions to the second TRP, wherein either: a maximum rank is 4, the first PTRS-DMRS association field is associated with a first SRS resource set that is associated to the first TRP, and the second PTRS-DMRS association field is associated with a second SRS resource set that is associated to the second TRP; or the first PTRS-DMRS association field is associated with a first TPMI field in the DCI that is associated to the first TRP, and the second PTRS-DMRS association field is associated with a second TPMI field in the DCI that is associated to the second TRP; or two PT-RS ports per TRP are configured, the maximum rank is 4, the first PTRS-DMRS association field is associated with the first SRS resource set, the second PTRS-DMRS association field is associated with the second SRS resource set, the first SRS resource set is associated with a first SRI field in the DCI associated to the first TRP, and the second SRS resource set is associated with a second SRI field in the DCI associated to the second TRP.

Corresponding embodiments of a wireless communication device are also disclosed. In one embodiment, a wireless communication device is adapted to receive DCI from a base station, wherein the DCI schedules PUSCH repetitions to two TRPs and the DCI comprises an antenna ports field that indicates two or more DMRS ports and a first PTRS-DMRS association field and a second PTRS-DMRS association field, each being a 2-bit field. The wireless communication device is further adapted to determine at least one DMRS port associated with at least one PTRS port for PUSCH transmissions to a first TRP based on a value of at least one PTRS-DMRS association field comprised in the DCI and determine at least one DMRS port associated with at least one PTRS port for PUSCH transmissions to a second TRP based on the value of the at least one PTRS-DMRS association field comprised in the DCI. The wireless communication device is further adapted to transmit a first PUSCH repetition to the first TRP with the at least one PTRS port for PUSCH transmissions to the first TRP and transmit a second PUSCH repetition to the second TRP with the at least one PTRS port for PUSCH transmissions to the second TRP, wherein either: a maximum rank is 4, the first PTRS-DMRS association field is associated with a first SRS resource set that is associated to the first TRP, and the second PTRS-DMRS association field is associated with a second SRS resource set that is associated to the second TRP; or the first PTRS-DMRS association field is associated with a first TPMI field in the DCI that is associated to the first TRP, and the second PTRS-DMRS association field is associated with a second TPMI field in the DCI that is associated to the second TRP; or two PT-RS ports per TRP are configured, the maximum rank is 4, the first PTRS-DMRS association field is associated with the first SRS resource set, the second PTRS-DMRS association field is associated with the second SRS resource set, the first SRS resource set is associated with a first SRI field in the DCI associated to the first TRP, and the second SRS resource set is associated with a second SRI field in the DCI associated to the second TRP.

Embodiments of a method performed by a base station are also disclosed. In one embodiment, a method performed by a base station comprises sending DCI to a wireless communication device, wherein: the DCI schedules PUSCH repetitions to two TRPs and the DCI comprises an antenna ports field that indicates two or more DMRS ports and a PTRS-DMRS association field, the PTRS-DMRS association field being a 2-bit field, wherein either: a MSB of the PTRS-DMRS association field is associated with a first TRP and a LSB of the PTRS-DMRS association field is associated with a second TRP, where the first TRP is associated with a first SRI field in the DCI and the second TRP is associated with a second SRI field in the DCI; or the MSB of the PTRS-DMRS association field is associated with a first SRS resource set associated to the first TRP and the LSB of the PTRS-DMRS association field is associated with a second SRS resource set associated to the second TRP, where the first SRS resource set is associated with the first SRI field in the DCI and the second SRS resource set is associated with the second SRI field in the DCI; or the MSB of the PTRS-DMRS association field is associated with a first TPMI field of the DCI associated to the first TRP and the LSB of the PTRS-DMRS association field is associated with a second TPMI field of the DCI associated to the second TRP.

In another embodiment, a method performed by a base station comprises receiving DCI to a wireless communication device, wherein the DCI schedules PUSCH repetitions to two TRPs and the DCI comprises an antenna ports field that indicates two or more DMRS ports and a first PTRS-DMRS association field and a second PTRS-DMRS association field, each being a 2-bit field, wherein either: a maximum rank is 4, the first PTRS-DMRS association field is associated with a first SRS resource set that is associated to a first TRP, and the second PTRS-DMRS association field is associated with a second SRS resource set that is associated to a second TRP; or the first PTRS-DMRS association field is associated with a first TPMI field in the DCI that is associated to the first TRP, and the second PTRS-DMRS association field is associated with a second TPMI field in the DCI that is associated to the second TRP; or two PT-RS ports per TRP are configured, the maximum rank is 4, the first PTRS-DMRS association field is associated with the first SRS resource set, the second PTRS-DMRS association field is associated with the second SRS resource set, the first SRS resource set is associated with a first SRI field in the DCI associated to the first TRP, and the second SRS resource set is associated with a second SRI field in the DCI associated to the second TRP.

Corresponding embodiments of a base station are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the Third Generation Partnership Project (3GPP) New Radio (NR) time-domain structure with 15 kilohertz (kHz) subcarrier spacing;

FIG. 2 illustrates the basic NR physical time-frequency resource grid;

FIG. 3 shows an example of Type 1 and Type 2 Demodulation Reference Signal (DMRS) with single-symbol DMRS;

FIG. 4 illustrates an example Phase Tracking Reference Signal for a Cyclic Prefix Orthogonal Frequency Division Multiplexing (CP-OFDM) based waveform;

FIG. 5 illustrates an example of Physical Uplink Shared Channel (PUSCH) repetition towards two Transmission/Reception Points (TRPs) scheduled by a Downlink Control Information (DCI) indicating two Sounding Reference Signal (SRS) Resource Indicator (SRI) fields;

FIG. 6 illustrates one example of a cellular communications system in which embodiments of the present disclosure may be implemented;

FIGS. 7A and 7B show an example of PUSCH repetitions towards two TRPs (denoted TRP #1 and TRP #2), where the PUSCH consists of two layers, each associated with one of DMRS ports 0 and 1;

FIG. 8 illustrates an example of SRS ports, DMRS ports, and PT-RS ports association in accordance with an embodiment of the present disclosure;

FIG. 9 illustrates an example of associating a DMRS port to a PT-RS port when two PT-RS per TRP are configured, in accordance with an embodiment of the present disclosure;

FIG. 10 illustrates an example of determining DMRS port to PTRS port association for PUSCH to a first TRP in case of rank 3, in accordance with an embodiment of the present disclosure;

FIGS. 11A and 11B illustrate the operation of a User Equipment (UE) and a NR base station (gNB) including two TRPs (TRP 1 and TRP 2) in accordance with some of the embodiments of the present disclosure;

FIGS. 12A and 12B illustrate the operation of a UE and a gNB including two TRPs (TRP 1 and TRP 2) in accordance with some other embodiments of the present disclosure;

FIGS. 13, 14, and 15 are schematic block diagrams of example embodiments of a network node;

FIGS. 16 and 17 are schematic block diagrams of example embodiments of a wireless device;

FIG. 18 illustrates an example embodiment of a communication system in which embodiments of the present disclosure may be implemented;

FIG. 19 illustrates example embodiments of the host computer, base station, and UE of FIG. 18; and

FIGS. 20, 21, 22, and 23 are flow charts that illustrate example embodiments of methods implemented in a communication system such as that of FIG. 18.

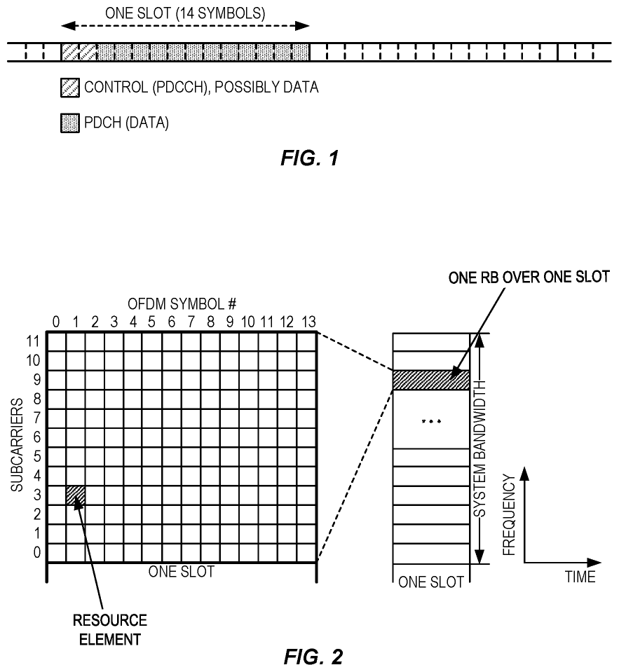

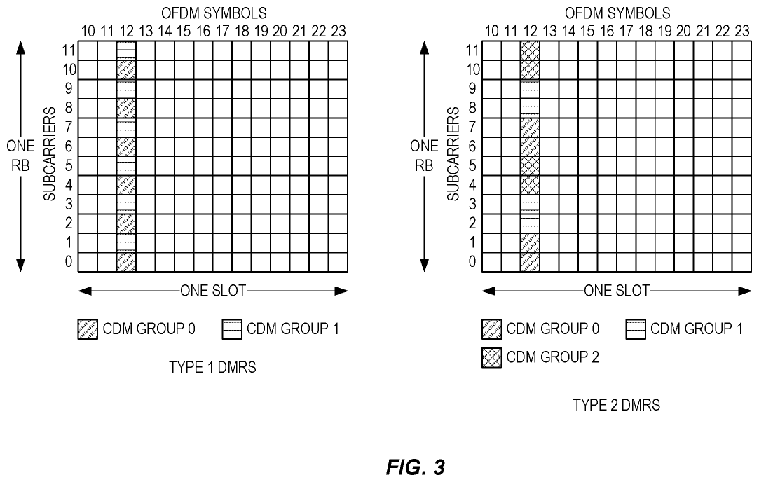

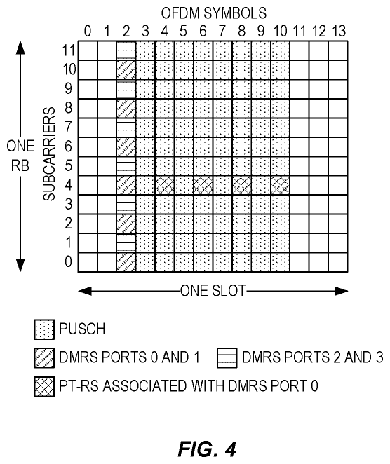

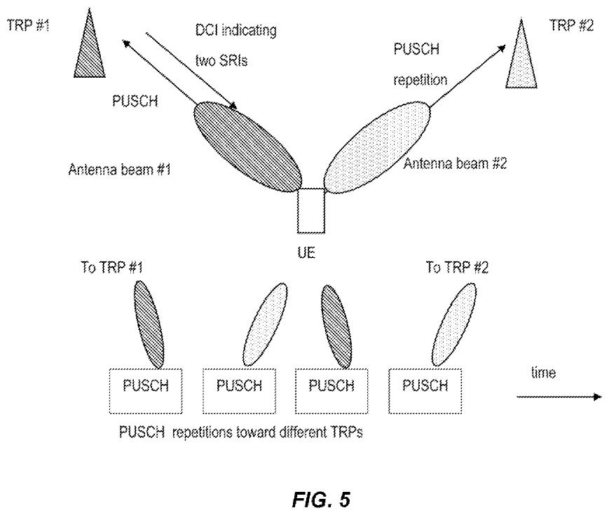

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.
Radio Node: As used herein, a “radio node” is either a radio access node or a wireless communication device.
Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.
Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.
Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.
Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.
Network Node: As used herein, a “network node” is any node that is either part of the RAN or the core network of a cellular communications network/system.
Transmission/Reception Point (TRP): In some embodiments, a TRP may be either a network node, a radio head, a spatial relation, or a Transmission Configuration Indicator (TCI) state. A TRP may be represented by a SRS resource set, an SRI field or a TPMI field in DCI, a spatial relation, or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). One problem is when a Physical Uplink Shared Channel (PUSCH) is scheduled using repetition with reception of multiple TRPs, the layer with strongest Signal to Interference plus Noise Ratio (SINR) will not be the same for all (both) TRPs. So even if the best layer is selected for a transmission towards the first TRP, it may in general not be the best for the repeated transmission toward the second TRP. Hence, phase tracking performance will degrade, which also implies that uplink throughput degrades.

The following problems arise for the Phase Tracking Reference Signal (PT-RS) when introducing support for PUSCH repetitions toward two or more TRPs:
How to support PT-RS towards multiple TRPs with PUSCH transmission of maximum rank>2 has not been discussed in 3GPP. The current agreement on using one bit per TRP for PT-RS to Demodulation Reference Signal (DM-RS) association indication is only for maximum rank=2.
How to support 2 PT-RS ports per TRP reception?
How to associate/map the 2 bits “PTRS-DMRS association” field in Downlink Control Information (DCI) to two TRPs, a valid open issue also for rank 2 and 3 transmissions?
How does a UE report its PT-RS capability in case of PUSCH transmission for multiple TRPs?

Certain aspects of the present disclosure and their embodiments may provide solutions to the aforementioned or other challenges. Systems and methods are disclosed herein that include one or more of the following aspects:
1. If a DCI indicating PUSCH repetition to two TRPs and one PT-RS port per TRP is configured,
   a. The Most Significant Bit (MSB) and Least Significant Bit (LSB) of the “PTRS-DMRS association” field in the DCI are associated with a first and second Sounding Reference Signal (SRS) Resource Indicator (SRI) fields, respectively, in the DCI for non-codebook based PUSCH transmission, and associated with a first and second Transmit Precoding Matrix Indicator (TPMI) fields in the DCI for codebook based PUSCH transmission. The first and second SRI or TPMI fields are associated with a first and second TRPs, respectively. If the SRI or TPMI fields are not present, the PT-RS field is ignored.
   b. In one embodiment, the above associations are applicable to maximum rank up to 2 or 4, and the MSB and LSB indicates one of the 1^{st} and 2^{nd} DMRS ports indicated in the “antenna ports” field in the DCI to be associated with a PT-RS port for a PUSCH transmission to a first and a second TRPs, respectively.
   c. In another embodiment, if rank 3 or 4 is indicated in the DCI, the MSB and LSB indicates one of the 1^{st} and 3^{rd} DMRS ports indicated in the “antenna ports” field in the DCI to be associated with a PT-RS port for a PUSCH transmission to a first and a second TRPs, respectively.
   d. In a further embodiment, the DCI may contain two “PTRS-DMRS association” fields, one associated with each TRP.
2. If PUSCH repetitions to two TRPs are scheduled by a DCI and two PT-RS ports, PT-RS ports 0 and 1, per TRP are configured,
   a. In one embodiment, the MSB of the “PTRS-DMRS association” field in the DCI is associated with PT-RS port 0 and the LSB of the field is associated with PT-RS port 1. The same PT-RS to DM-RS association indicated the “PTRS-DMRS association” field in the DCI is applied to both TRPs.
   b. In another embodiment, the “PTRS-DMRS association” field in the DCI is only for the first TRP. The PTRS to DMRS association for the second TRP is predetermined.
   c. In a further embodiment, the MSB and LSB of the “PTRS-DMRS association” field in the DCI are for the first and second TRPs, respectively. For each TRP, a first and a second DMRS ports are selected from a first and second DMRS port groups for PT-RS ports 0 and 1, respectively, where the first and second DMRS ports are associated with a first and a second PUSCH or SRS port groups, respectively. The selection is rank dependent.
   d. In one embodiment both a and b can be supported, higher layer configures one of them to the UE.
3. The PT-RS to PUSCH power ratio can be configured per TRP.

In some embodiments, a single two bit “PTRS-DMRS association” field in a DCI scheduling PUSCH repetitions to two TRPs is used to indicate one or two DMRS ports that are associated with one or two PTRS ports for PUSCH transmissions to each TRP. Using a single “PTRS-DMRS association” field with 2 bits can save DCI overhead and the same filed can be shared with legacy PUSCH transmission to a single TRP.

Since the PUSCH repetition to each TRP can have up to 4 layers, each associated with a DMRS port, how to use the two bits to indicate one or two DMRS ports out of up to 4 DMRS ports for each of the two TRPs is the issue.

In one embodiment, the MSB and LSB of the “PTRS-DMRS association” field are for a first and second TRP, respectively. Only the first two DMRS ports can be selected for PT-RS port association even though 3 or 4 DMRS ports may be indicated in the DCI. The drawback is that if the strongest layer is associated with the 3^{rd} or 4^{th} DMRS port, phase tracking performance would be degraded.

In another embodiment, the DMRS-PTRS indication in the DCI is always associated with PUSCH transmissions to one of the two TRPs (e.g., a first TRP) when repetition is configured. For PUSCH repetitions toward a second TRP, a default DMRS-PTRS indication, specified in the standard, is used. For example, the first DMRS port always shares a PTRS port. This means that on average, no SINR gain is obtained for PTRS transmission towards the second TRP, while it is obtained towards the first TRP.

In a further embodiment, if two PT-RS ports are configured for PUSCH transmission and PUSCH repetition towards two TRPs is scheduled, the DMRS ports {k1,k2,k3,k4} indicated in the DCI are divided into two DMRS port groups, DMRS port groups A and B. DMRS port group A is associated with SRS port group consisting of SRS ports 1000 and 1002 in an SRS resource in a first (or second) SRS resource set associated with the first (or second) SRI field in the DCI. DMRS port group B is associated with SRS port group consisting of SRS ports 1001 and 1003. The MSB and LSB of the “PTRS-DMRS association” field in the DCI are for a first and second TRP, respectively.

If rank 4 is indicated in the DCI, DMRS port group A consists of DMRS ports {a1,a2} (ai∈{k1, k2, k3, k4}, i=1,2.)and DMRS port group B consists of DMRS ports {b1,b2} (bi∈{k1, k2, k3, k4}, i=1,2.). The first and second DMRS ports associated respectively with a first and a second PT-RS ports are determined as DMRS ports a1 and b1, respectively, if the MSB (or LSB) of the “PTRS-DMRS association” field is 0, or as DMRS ports a2 and b2, respectively, if the MSB (or LSB) of the “PTRS-DMRS association” field is 1.

If rank 3 is indicated, one DMRS port group would have one DMRS port and the other DMRS port group would have 2 DMRS ports. The MSB (or LSB) of the “PTRS-DMRS association” field indicates a DMRS port in the DMRS port group with two DMRS ports for the associated PT-RS port.

If rank 2 is indicated and if the associated 2 DMRS ports are in the same DMRS port group, a single PTRS port would be transmitted. The MSB (or LSB) of the “PTRS-DMRS association” field indicates a DMRS port in the DMRS port group with two DMRS ports for the single PT-RS port. Otherwise, if each DMRS port group contains one DMRS port, the “PTRS-DMRS association” field can be ignored. The first or second DMRS ports is the DMRS port in the first or second DMRS port group, respectively.

In yet another embodiment, two two-bits “PTRS-DMRS association” fields, one for each TRP, may be contained in the DCI.

In another embodiment, a first and second PT-RS to PUSCH energy per resource element (EPRE) ratios are configured for the first and the second TRPs, respectively.

Certain embodiments may provide one or more of the following technical advantage(s). Embodiments of the solution(s) described herein may enable PUSCH repetition with 2 PT-RS ports transmitted to each TRP when partial or non-coherent antenna ports are used in a UE. Embodiments may allow PUSCH repetition with rank>2 towards two TRPs for better UL UE throughput without increasing DCI overhead.

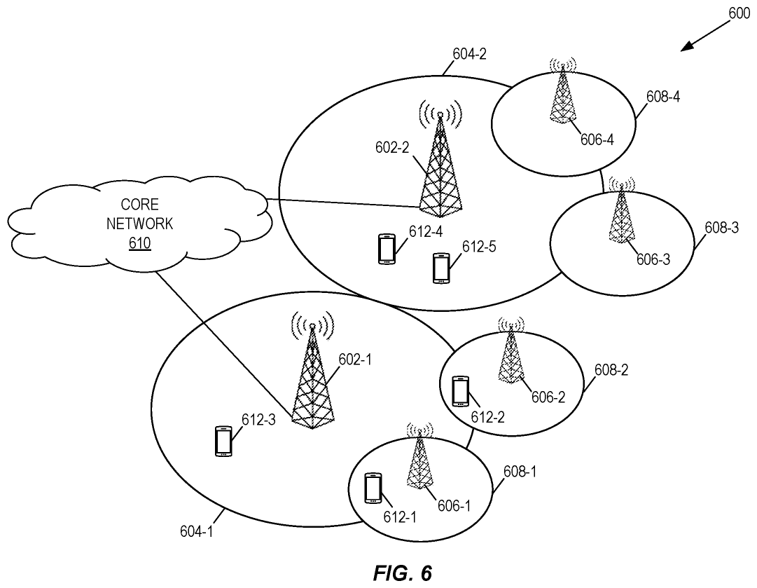

FIG. 6 illustrates one example of a cellular communications system 600 in which embodiments of the present disclosure may be implemented. In the embodiments described herein, the cellular communications system 600 is a 5G system (5GS) including a Next Generation RAN (NG-RAN) and a 5G Core (5GC); however, the present disclosure is not limited thereto. Embodiments of the present disclosure may be used in any type of wireless or cellular communications system in which multi-TRP transmission is desired. In this example, the RAN includes base stations 602-1 and 602-2, which in the 5GS include NR base stations (gNBs) and optionally next generation eNBs (ng-eNBs), controlling corresponding (macro) cells 604-1 and 604-2. The base stations 602-1 and 602-2 are generally referred to herein collectively as base stations 602 and individually as base station 602. Likewise, the (macro) cells 604-1 and 604-2 are generally referred to herein collectively as (macro) cells 604 and individually as (macro) cell 604. The RAN may also include a number of low power nodes 606-1 through 606-4 controlling corresponding small cells 608-1 through 608-4. The low power nodes 606-1 through 606-4 can be small base stations (such as pico or femto base stations) or RRHs, or the like. Notably, while not illustrated, one or more of the small cells 608-1 through 608-4 may alternatively be provided by the base stations 602. The low power nodes 606-1 through 606-4 are generally referred to herein collectively as low power nodes 606 and individually as low power node 606. Likewise, the small cells 608-1 through 608-4 are generally referred to herein collectively as small cells 608 and individually as small cell 608. The cellular communications system 600 also includes a core network 610, which in the 5GS is referred to as the 5GC. The base stations 602 (and optionally the low power nodes 606) are connected to the core network 610.

The base stations 602 and the low power nodes 606 provide service to wireless communication devices 612-1 through 612-5 in the corresponding cells 604 and 608. The wireless communication devices 612-1 through 612-5 are generally referred to herein collectively as wireless communication devices 612 and individually as wireless communication device 612. In the following description, the wireless communication devices 612 are oftentimes UEs and as such sometimes referred to herein as UEs 612, but the present disclosure is not limited thereto.

Now a description of embodiments of the present disclosure will be provided.

### 1 Indicating UL PT-RS for Multiple TRPs

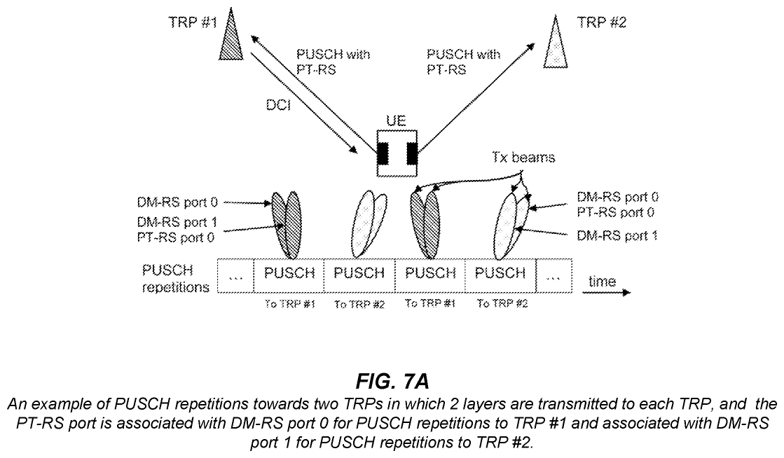

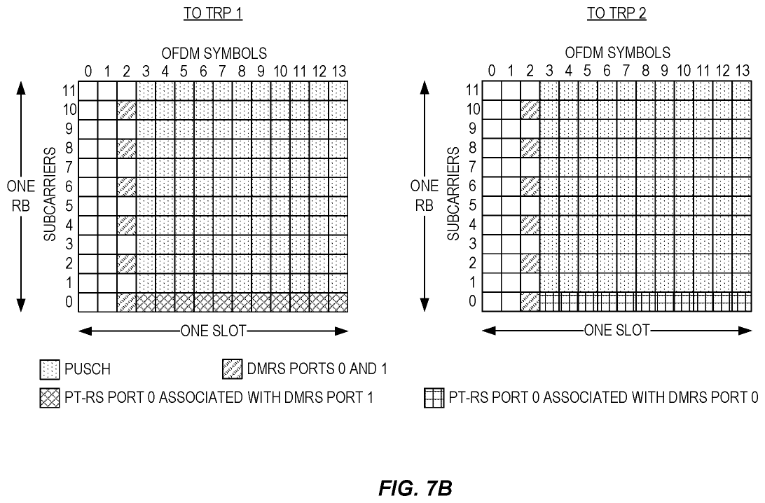

FIGS. 7A and 7B show an example of PUSCH repetitions towards two TRPs (denoted TRP #1 and TRP #2), where the PUSCH consists of two layers, each associated with one of DM-RS ports 0 and 1. The same number of layers are transmitted to each TRP and the same time and frequency resource is used in each slot. The PUSCH repetitions can be dynamically scheduled with a DCI (e.g., DCI format 0_1 or DCI format 0_2). For phase tracking purpose, a PT-RS port is also transmitted together with each PUSCH transmission in the example. Because the channel to the two TRPs can be different, the strongest layer can be different for the two TRPs. In this example, the strongest layer to TRP #1 is the layer associated with DM-RS port 1 while the strongest layer to TRP #2 is the layer associated with DM-RS port 0. For best phase tracking performance, the PT-RS port should be associated with the strongest layer in each PUSCH repetition. Thus, in this example, the PT-RS port is associated with DM-RS port 1 for PUSCH transmissions to TRP #1 and is associated with DM-RS port 0 for PUSCH transmissions to TRP #2. Association here means that a PT-RS port is located in one of the subcarriers over which the associated DM-RS port is allocated and the PT-RS symbols in a subcarrier are the same as the associated DM-RS symbol at the same subcarrier.

In embodiments described herein, the association between a PT-RS port with a DM-RS port for each TRP is indicated by a 2 bit PT-RS to DM-RS association bit field in a DCI scheduling the corresponding PUSCH repetitions.

Note that the term “TRP” may not directly appear in the 3GPP standard specifications, instead an SRS resource set, an SRI field, a TPMI field, a spatial relation or UL TCI state field, may be used as part of the standard, which are then equivalent to indicating a certain TRP.

### 1.1 One PT-RS Port Per TRP Configured by Higher Layers

In some of the following embodiments, a single PTRS-DMRS association field in DCI is assumed.

When one PT-RS port is configured by the higher layers for PUSCH transmission and if PUSCH repetition to two TRPs is scheduled by a DCI, in one embodiment, for non-codebook based PUSCH transmission configured with two SRS resource sets with usage set to “non-codebook”, the most significant bit (MSB) of the “PTRS-DMRS association” field in the DCI is associated with a first TRP (or a first SRS resource set) and the least significant bit (LSB) is associated with a second TRP (or a second SRS resource set), where the first and second TRPs (or the first and second SRS resource sets) are associated with a first and second SRI fields in the DCI if the SRI fields are present. If the SRI fields are not present, the PT-RS field is ignored because it implies single layer PUSCH transmission with a single DMRS port. The PTRS port would be associated with the DMRS port, and there is no need for explicit indication of PTRS to DMRS association using the PTRS-DMRS association field. One example is shown in Table 1, where the MSB is for a first TRP associated with a first SRS resource set and the LSB is for a second TRP associated with a second SRS resource set.

TABLE 1
PTRS-DMRS association for UL PTRS port of PUSCH repetitions
when two SRS resource sets are configured with usage
set to “nonCodebook”.

| | DMRS port associated | | DMRS port associated |
|---|---|---|---|
| | with a first TRP (i.e., | | with a second TRP (i.e., |
| Value of | a first SRI field in | Value of | a second SRI field in |
| MSB | DCI) | LSB | DCI) |
| 0 | 1^{st} DMRS port which | 0 | 1^{st} DMRS port which |
| | shares PTRS port 0 | | shares PTRS port 0 |
| 1 | 2^{nd} DMRS port which | 1 | 2^{nd} DMRS port which |
| | shares PTRS port 0 | | shares PTRS port 0 |

For codebook based PUSCH transmission, the MSB and LSB of the “PTRS-DMRS association” field in the DCI are associated with a first and second TRPs (or TPMI fields) in the DCI, respectively, where the first and second TPMI fields are associated with a first and second TRPs (or a first and second SRS resource sets). If the TPMI fields are not present, the “PTRS-DMRS association” field is ignored. One example is shown in Table 2, where the MSB is for a first TRP associated with a first SRS resource set and the LSB is for a second TRP associated with a second SRS resource set. Note that the first TPMI field can be an existing “Precoding information and number of layers” field in DCI format 0_1 or DCI format 0_2, the second TMPI field can be a new field containing only precoding information in DCI format 0_1 or DCI format 0_2.

TABLE 2
PTRS-DMRS association for UL PTRS port of PUSCH
repetitions when two SRS resource sets are configured
with usage set to “Codebook”.

| | DMRS port associated | | DMRS port associated |
|---|---|---|---|
| | with a first TRP (i.e., | | with a second TRP (i.e., |
| Value of | a first TPMI field in | Value of | a second TPMI field in |
| MSB | DCI) | LSB | DCI) |
| 0 | 1^{st} DMRS port which | 0 | 1^{st} DMRS port which |
| | shares PTRS port 0 | | shares PTRS port 0 |
| 1 | 2^{nd} DMRS port which | 1 | 2^{nd} DMRS port which |
| | shares PTRS port 0 | | shares PTRS port 0 |

It is noted that in both the example of Table 1 and the example of Table 2, one of 1^{st} and 2^{nd} DMRS ports can be selected. In one embodiment, the above associations are applicable only to maximum rank 2. Ranks 3 and 4 are not supported for PUSCH repetitions to multiple TRPs.

In another embodiment, the above associations are applicable also to maximum rank from 1 to 4, in this case, the 3^{rd} and 4^{th} layer cannot be selected for DMRS-PTRS port association. In this case, phase tracking performance may be degraded if the strong PUSCH layer is associated with one of the 3^{rd} and 4^{th} DMRS ports.

Alternatively, it is observed by analyzing the codebook structure for partial coherent codebook for 4 layers (i.e., TPMI index 2 and 3 for the matrices in Table 6.3.1.5-7 of 3GPP TS 38.211, precoding matrix for TPMI with index

$$2 = \frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ] ,$$

precoding matrix for TPMI with index

$$3 = \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] )$$

that the 1^{st} and 2^{nd} layers (i.e., associated with the 1^{st} and 2^{nd} columns of the TMPI) are jointly precoded and transmitted from one subset of the transmit antennas (i.e., SRS or PUSCH antenna ports 1000 and 1002). The reason is that these are typically associated with two co-located antennas with two different polarizations and such two polarizations often have similar SINR. Hence, for full rank transmission (rank 4 in this case), and partial coherent precoder selection, there is a slight benefit of indicating either 1^{st} and 3^{rd} DMRS port to be associated with PTRS port 0, since they are most likely to differ more in SINR compared to 1^{st} and 2^{nd} or 3^{rd} and 4^{th} DMRS ports. Therefore, the use of the 2^{nd} and 4^{th} DMRS port is excluded from the DMRS-PTRS port 0 association. Instead, the two bits are used to select among 1^{st} and 3^{rd} DMRS port for first and second TRP, respectively. This applies when rank=4 is used and TPMI=2 or 3.

For the same reason, the 1^{st} and 3^{rd} DMRS ports may be selected for PTRS association for the first and second TRP, respectively. Therefore, in case of rank 3 or 4, Table 3 is applied.

TABLE 3
PTRS-DMRS association for UL PTRS port of PUSCH repetitions when
two SRS resource sets are configured with usage set to “Codebook”
and rank = 3, or 4 is indicated in the TMPI fields of DCI.

| | DMRS port associated | | DMRS port associated |
|---|---|---|---|
| | with a first TRP (i.e., | | with a second TRP (i.e., |
| | the first SRS resource | | the second SRS resource |
| Value of | set, or a first SRI/ | Value of | set, or a second SRI/ |
| MSB | TPMI field in DCI) | LSB | TPMI field in DCI) |
| 0 | 1^{st} DMRS port which | 0 | 1^{st} DMRS port which |
| | shares PTRS port 0 | | shares PTRS port 0 |
| 1 | 3^{rd} DMRS port which | 1 | 3^{rd} DMRS port which |
| | shares PTRS port 0 | | shares PTRS port 0 |

In a further embodiment, Table 3 is applied only when the codebook subset is configured as “partialAndNonCoherent” and/or “nonCoherent”, or certain TPMIs are indicated.

In an alternative embodiment, when one PT-RS port per TRP is configured by the higher layers and if PUSCH repetition to two TRPs is scheduled by a DCI for non-codebook based PUSCH transmission, two “PTRS-DMRS association” fields are present in the DCI when the maximum number of PUSCH transmission layers (i.e., rank) is configured to be 4. The first “PTRS-DMRS association” field in the DCI is associated with a first SRS resource set, and the second “PTRS-DMRS association” field in the DCI is associated with a second SRS resource set, where the first and second SRS resource sets are associated with a first and second SRI fields in the DCI if the SRI fields are present. If the SRI fields are not present, the PT-RS field is ignored. Note that in some cases, each “PTRS-DMRS association” field may be directly associated with each SRI field in DCI.

In another embodiment, even when two SRS resource sets are configured (i.e., two SRI fields are in the scheduling DCI), the UE may only schedule PUSCH transmission towards one of the TRPs. In this embodiment, PUSCH is repeated over multiple transmission occasions towards the same TRP using the SRIs indicated in one of the two SRI fields in DCI (while the other SRI field is ignored by the UE). Then, for associating PTRS to DMRS, the UE would use the “PTRS-DMRS association” field that is associated with the SRS resource set that corresponds to the SRI field used for PUSCH scheduling. For example, if PUSCH is only scheduled according to the first SRI field, then the UE only uses the first “PTRS-DMRS association” field to determine the PT-RS to DMRS association. In this example, the first SRI field and the first “PTRS-DMRS” association field both correspond to the same SRS resource set (e.g., first SRS resource set). This embodiment may be applicable to either codebook based or non-codebook based PUSCH transmission. This embodiment is applicable when 1 or 2 PTRS ports per TRP are configured by higher layers.

In another embodiment, for codebook based PUSCH transmission, where two “PTRS-DMRS association” fields are present in DCI, the first and second “PTRS-DMRS association” fields in the DCI are associated with a first and second TPMI fields in the DCI, respectively. This embodiment is applicable when the TPMI fields are present, where the first and second TPMI fields are associated with a first and second SRS resource sets. If the TPMI fields are not present, the “PTRS-DMRS association” fields are ignored.

When one PT-RS port is configured by the higher layers and if PUSCH to a single TRP is scheduled by a DCI, PT-RS to DM-RS association is according to Table 7.3.1.1.2-25 of 3GPP TS 38.212. In some embodiments, when one PT-RS port is configured by higher layers and if PUSCH to multiple TRPs is scheduled via a DCI that contains two “PTRS-DMRS association” fields (i.e., one field per TRP), the PT-RS to DM-RS association corresponding to each of the two “PTRS-DMRS association” fields is according to Table 7.3.1.1.2-25 of 3GPP TS 38.212.

In one additional embodiment, when PUSCH repetition towards two or more TPRs is configured, then the PTRS-DMRS associations are only valid for the transmissions towards one of the TRPs (e.g., the first one/lowest SRI), while a default association, given by the specifications (e.g., always 1^{st} DMRS port which shares a PTRS port), is used for other TRPs.

### 1.2 Two PT-RS Ports Per TRP Configured by the Higher Layers

In at least some of the following embodiments, a single PTRS-DMRS association field in DCI is assumed.

When two PT-RS ports, PT-RS ports 0 and 1, per TRP are configured by the higher layers for PUSCH transmission and if PUSCH repetition to two TRPs is scheduled by a DCI, in one embodiment, the MSB of the “PTRS-DMRS association” field in the DCI is associated with PT-RS port 0 and the LSB of the field is associated with PT-RS port 1. The same PT-RS to DM-RS association indicated the “PTRS-DMRS association” field in the DCI is applied to PUSCH transmissions to both TRPs.

Alternatively, the MSB of the “PTRS-DMRS association” field in the DCI is for the first TRP and the LSB of the field is for the second TRP. The MSB indicates the DMRS port associated with PT-RS port 0, the DMRS port associated with PT-RS port 1 is derived from the DMRS port associated with PT-RS port 0.

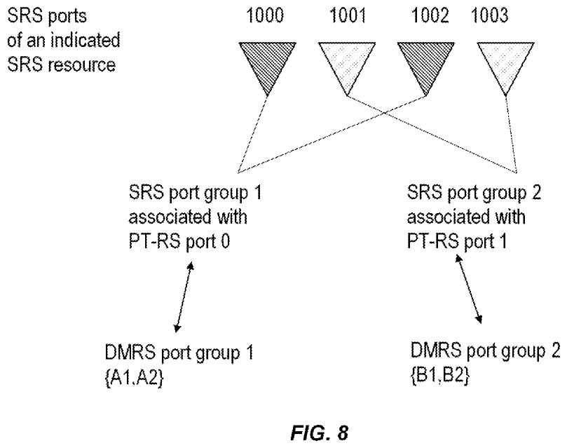

An example of SRS ports, DMRS ports, and PT-RS ports is shown in FIG. 8, where it is assumed that the first SRI field in the DCI indicates a SRS resource with 4 ports, ports 1000 to 1003, the associated TPMI field (e.g., the first TPMI field) in the DCI indicates rank 4 and a TPMI, and the “antenna ports” field in the DCI indicated four DMRS ports {k1,k2,k3,k4}. According to 3GPP TS38.214, SRS ports 1000 and 1002 are associated with one PTRS port and SRS ports 1001 and 1003 are associated with another PTRS port if two PT-RS ports are configured. SRS ports 1000 and 1002 forms a first SRS port group and SRS ports 1001 and 1003 form a second SRS port group. Note that SRS ports and PUSCH ports are the same, they are exchangeable.

For rank 4, there are two DMRS ports, {A1,A2}, associated with the first SRS port group and another two DMRS ports, {B1,B2}, associated with the second SRS port group, where Ai, Bi∈{k1, k2, k3, k4}, i=1,2. The DMRS ports to SRS ports association is implicitly indicated in the TPMI. For example, if TPMI index 2 in Table 6.3.1.5-7 of 3GPP TS 38.211 is indicated, the corresponding precoding matrix is

$$\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ] ,$$

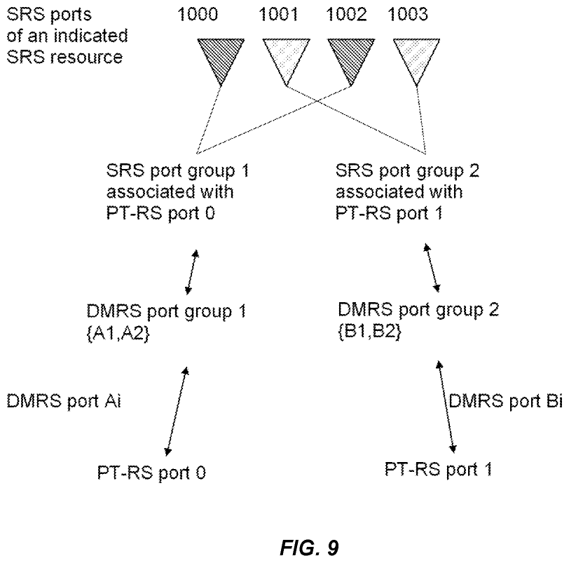

then the first two DMRS ports are associated with the first SRS port group and the next two DMRS ports are associated with the second SRS port group. The MSB of the “PTRS-DMRS association” field in the DCI indicates either DMRS port A1 for PT-RS port 0 and DMRS port B1 for PT-RS port 1 if the MSB=0, or DMRS port A2 for PT-RS port 0 and DMRS port B2 for PT-RS port 1 if the MSB=1. This is illustrated in FIG. 9.

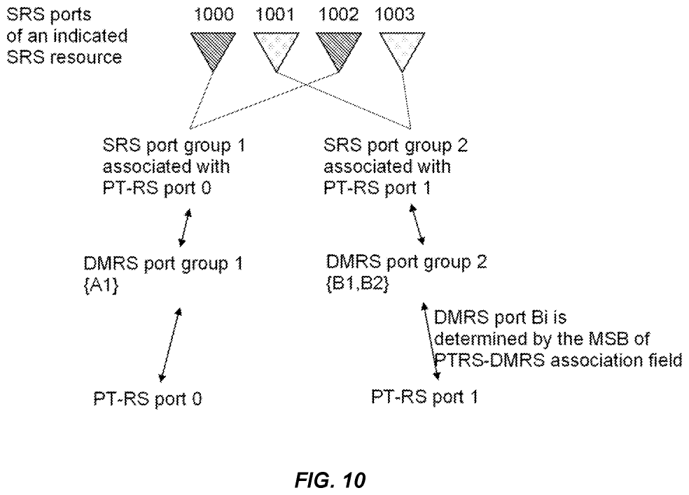

In case that rank 3 is indicated, one DMRS port would be associated with one SRS port group and two DMRS ports would be associated with the other SRS port group, the MSB of the “PTRS-DMRS association” field indicates one of the two DMRS ports in an SRS port group for the PT-RS port associated with the SRS port group. For example, if the first DMRS port is associated with the first SRS port group and the 2^{nd} and 3^{rd} DMRS ports are associated with the second SRS port group, and if the MSB is set to 0, the 2^{nd} DMRS port is selected for PTRS port 1. Otherwise, if the MSB is set to 1, the 3^{rd} DMRS port is selected for PTRS port 1. The 1^{st} DMRS port is associated with PT-RS port 0. This example of determining DMRS port to PTRS port association for PUSCH to a first TRP in the case of rank 3 is shown in FIG. 10.

In case that rank 2 is indicated and if the associated 2 DMRS ports are associated with a same SRS port group, then the MSB of the “PTRS-DMRS association” field indicates one of the two DMRS port for a PT-RS port associated with the SRS port group, and the other PT-RS port is not transmitted. Otherwise, the “PTRS-DMRS association” field can be ignored and each PTRS port is associated with the DMRS port associated with each SRS port group.

The same procedures above apply to DMRS ports determination for PT-RS ports with the LSB of the “PTRS-DMRS association” field in DCI for the second TRP.

When two PT-RS ports are configured by the higher layers and if PUSCH to a single TRP is scheduled by a DCI, PT-RS to DM-RS association is according to Table 7.3.1.1.2-26 of 3GPP TS 38.212.

In one additional embodiment, when PUSCH repetition towards two or more TPRs is configured, then the PTRS-DMRS associations are only valid for the transmissions towards one of the TRPs (e.g., associated with the first SRI field in DCI), while to other ones use a default association, given by the specifications (e.g., always 1^{st} DMRS port which shares a PTRS port).

In an alternative embodiment, when two PT-RS ports (PT-RS ports 0 and 1) per TRP are configured by the higher layers and if PUSCH repetition to two TRPs is scheduled by a DCI, two “PTRS-DMRS association” fields are present in the DCI when the maximum number of PUSCH transmission layers (i.e., rank) is configured to be 4. The first “PTRS-DMRS association” field in the DCI is associated with a first SRS resource set, and the second “PTRS-DMRS association” field in the DCI is associated with the second SRS resource set, where the first and second SRS resource sets are associated with a first and second SRI fields in the DCI if the SRI fields are present. If the SRI fields are not present, the first and second “PTRS-DMRS association” fields in the DCI are associated with a first and second TPMI fields in the DCI. If both the SRI and the TPMI fields are not present, the PT-RS field is ignored. The PT-RS to DMRS association for each of the two “PTRS-DMRS association” fields is according to the Table 7.3.1.1.2-25 of 3gpp TS 38.212.

In another embodiment, for non-codebook based PUSCH towards two TRPs, the number of PT-RS ports determined for each TRP may be different (i.e., 1 PT-RS port for TRP1 and 2 PT-RS ports for TRP2). In this case, two “PTRS-DMRS association” fields in the DCI may be used to provide the association between PT-RS and DMRS for each TRP. The number of PTRS ports per TRP are determined based on the SRIs indicated by two SRI fields (i.e., one SRI field corresponding to each TRP) in DCI. For the PUSCH transmission (or a subset of PUSCH repetitions) corresponding to a single PT-RS port, the PTRS-DMRS association is provided by the corresponding “PTRS-DMRS association” field according to Table 7.3.1.1.2-25 of 3GPP TS 38.212. For PUSCH transmission (or the remaining set of PUSCH repetitions) corresponding to two PT-RS ports, the PTRS-DMRS association is provided by the corresponding “PTRS-DMRS association” field according to Table 7.3.1.1.2-26 of 3GPP TS 38.212.

### 1.3 UE Capability Signaling for PT-RS

For PUSCH repetition towards multiple TRPs, a UE may report a new capability on number of PT-RS ports supported, which is in addition to the existing reporting parameters, i.e., “onePortsPTRS”,“twoPortsPTRS-UL” (see 3gpp TS 38.306 v16.3.0). The new parameter would indicate the maximum number of PT-RS ports toward each TRP and is applicable only to PUSCH repetitions to multiple TRPs. The reason is that different receive antenna panels could be used at a UE for PUSCH transmission to a single TRP and to multiple TRPs.

### 1.4 PT-RS Power Boosting

The factor related to PUSCH to PT-RS power ratio per layer per RE is indicated to UE by power boosting factor ptrs-Power in PTRS-UplinkConfig IE via higher layer configuration.

For PT-RS for PUSCH to multiple TRPs, separate power boosting configuration per TRP may be supported. The PT-RS boosting factor per TRP can be configured differently for each TRP. The value indicated via ptrs-Power in PTRS-UplinkConfig IE can be used to support 2 TRPs. In one embodiment, value p00, p01 is used when both TRPs are configured with same power boosting, value p10, p11 is used when different power boosting factor is configured for the first and second TRP.

When PT-RS for 2 TRPs is configured, and if a UE is capable of apply different power boosting factors to PT-RS associated with different TRPs, p10 and p11 can be used to configure ptrs-Power. UE applies power boosting factor 00 for the first TRP, power boosting factor 01 for the second TRP when p10 is configured; UE applies power boosting factor 01 for the first TRP, power boosting factor 00 for the second TRP when p11 is configured. An example is showed in Table 4. An alternative way is to map p10 to TRP0 01, TRP1 00; to map p11 to TRP 0 00, TRP1 01.

TABLE 6.2.3.1-3
Factor related to PUSCH to PT-RS power ratio per layer per REα_{PTRS}^{PUSCH}

| | | The number of PUSCH layers (n_{layer}^{PUSCH}) | | | | | | |
|---|---|---|---|---|---|---|---|---|
| | | 2 | | 3 | | | | |
| | | | Partial and | | Partial and | 4 | | |
| UL-PTRS- | 1 | | non-coherent | | non-coherent | | | Non-coherent |
| power/ | All | Full | and non- | Full | and non- | Full | Partial | and non- |
| α_{PTRS}^{PUSCH} | cases | coherent | codebook based | coherent | codebook based | coherent | coherent | codebook based |
| 00 | 0 | 3 | 3Qₚ − 3 | 4.77 | 3Qₚ − 3 | 6 | 3Qₚ | 3Qₚ − 3 |
| 01 | 0 | 3 | 3 | 4.77 | 4.77 | 6 | 6 | 6 |

| | |
|---|---|
| 10 | Reserved |
| 11 | Reserved |

TABLE 4
Mapping of power booting factor for 2 TRPs

| | | Applied boosting power ratio |
|---|---|---|
| ptrs-Power | TRP number | in table 6.2.1.1-3 |
| p00 | TRP0 | 00 |
| | TRP1 | 00 |
| p01 | TRP0 | 01 |
| | TRP1 | 01 |
| p10 | TRP0 | 00 |
| | TRP1 | 01 |
| p11 | TRP0 | 10 |
| | TRP1 | 00 |

### 2 Further Description

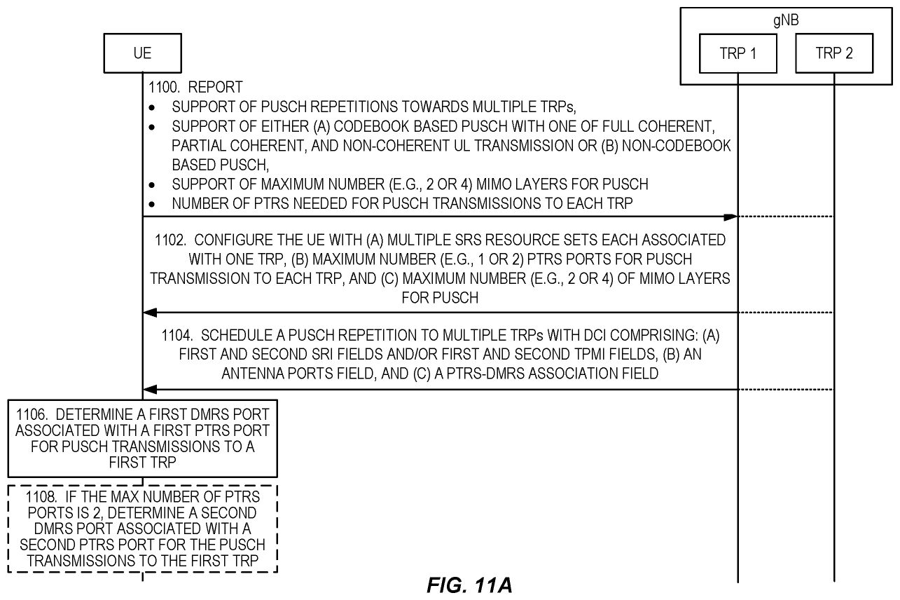

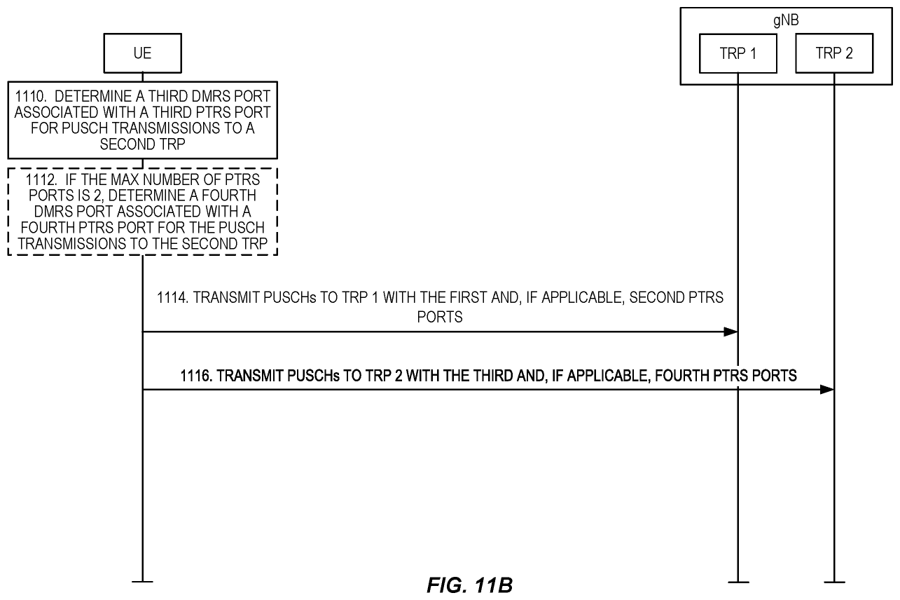

FIGS. 11A and 11B illustrate the operation of a UE 612 and a gNB 602 including two TRPs (TRP 1 and TRP 2) in accordance with some of the embodiments described above. Optional steps are represented by dashed lines/boxes. As illustrated, the UE 612 reports, to the gNB 602, information including (A) support for PUSCH repetitions towards multiple TRPs, (B) support for either codebook based PUSCH with full coherent, partial-coherent, or non-coherent UL transmission, (C) support of a maximum number (e.g., 2 or 4) MIMO layers for PUSCH, and (D) a number of PTRS ports needed for PUSCH transmissions to each TRP (step 1100). Note that while in this example the UE 612 reports all of the aforementioned information to the gNB 602, in some embodiments, the UE 612 may only report some of this information to the gNB 602. The gNB 602 configures the UE 612 with (A) multiple SRS resource sets each associated with one TRP, (B) a maximum (e.g., 1 or 2) number of PTRS ports for PUSCH transmission to each TRO, and (C) a maximum number (e.g., 2 or 4) of MIMO layers for PUSCH (step 1102).

The gNB 602 sends, to the UE 612, a DCI scheduling a PUSCH repetition to multiple TRPs, where this DCI includes: (a) first and second SRI fields (for non-codebook based PUSCH and possibly for codebook based PUSCH) and/or first and second TPMI fields (possibly for codebook based PUSCH), (b) an antenna port field, and (c) a PTRS-DMRS association field (step 1104). Note that various embodiments of this DCI, and in particular, the usage of the PTRS-DMRS association field are described above and the details of those embodiments are applicable here. The UE 612 receives the DCI and, based on the DCI, determines a first DMRS port associated with a first PTRS port for PUSCH transmissions to the first TRP (TRP 1) (step 1106). If the maximum number of PTRS ports is 2, the UE 612 also determines a second DMRS port associated with a second PTRS port for the PUSCH transmissions to the first TRP (step 1108). The UE 612 also determines, based on the DCI, a third DMRS port associated with a third PTRS port for PUSCH transmissions to the second TRP (TRP 2) (step 1110). If the maximum number of PTRS ports is 2, the UE 612 also determines a fourth DMRS port associated with a fourth PTRS port for the PUSCH transmission to the second TRP (step 1112). The UE 612 transmits PUSCHs to the first TRP (TRP 1) with the first PTRS port and, if applicable, the second PTRS port (step 1114). The UE 612 transmits PUSCHs to the second TRP (TRP 2) with the third PTRS port and, if applicable, the fourth PTRS port (step 1116).

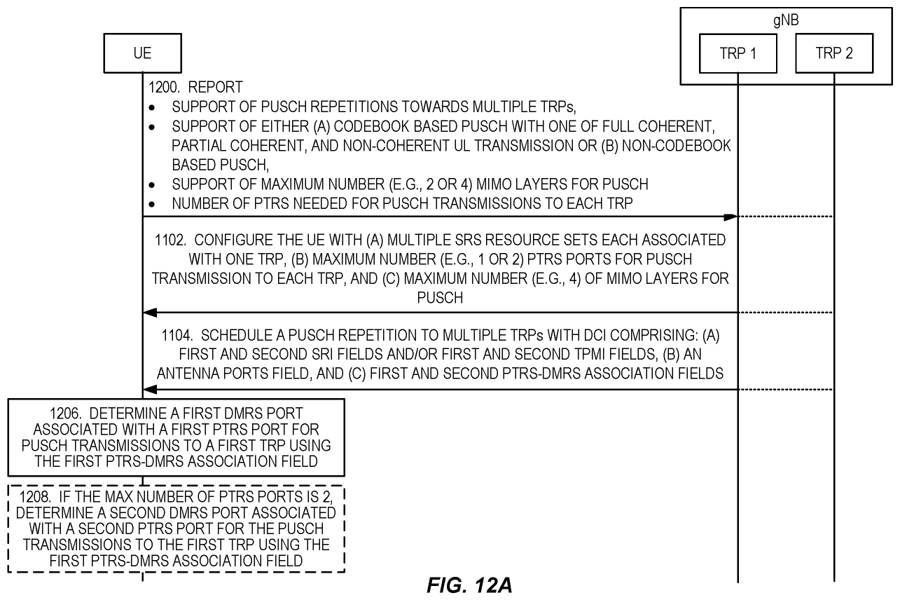

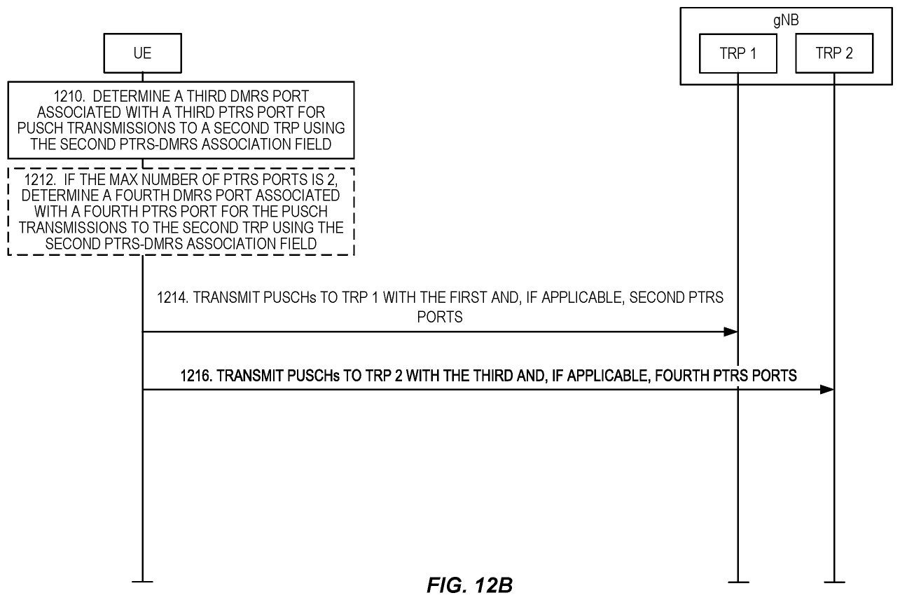

FIGS. 12A and 12B illustrate the operation of a UE 612 and a gNB 602 including two TRPs (TRP 1 and TRP 2) in accordance with some others of the embodiments described above. Optional steps are represented by dashed lines/boxes. As illustrated, the UE 612 reports, to the gNB 602, information including (A) support for PUSCH repetitions towards multiple TRPs, (B) support for either codebook based PUSCH with full coherent, partial-coherent, or non-coherent UL transmission, (C) support of a maximum number (e.g., 2 or 4) MIMO layers for PUSCH, and (D) a number of PTRS ports needed for PUSCH transmissions to each TRP (step 1200). Note that while in this example the UE 612 reports all of the aforementioned information to the gNB 602, in some embodiments, the UE 612 may only report some of this information to the gNB 602. The gNB 602 configures the UE 612 with (A) multiple SRS resource sets each associated with one TRP, (B) a maximum (e.g., 1 or 2) number of PTRS ports for PUSCH transmission to each TRO, and (C) a maximum number (e.g., 4) of MIMO layers for PUSCH (step 1202).

The gNB 602 sends, to the UE 612, a DCI scheduling a PUSCH repetition to multiple TRPs, where this DCI includes: (a) first and second SRI fields (for non-codebook based PUSCH and possibly for codebook based PUSCH) and/or first and second TPMI fields (possibly for codebook based PUSCH), (b) an antenna port field, and (c) first and second PTRS-DMRS association fields (step 1204). Note that various embodiments of this DCI, and in particular, the usage of the two PTRS-DMRS association fields are described above and the details of those embodiments are applicable here. The UE 612 receives the DCI and determines a first DMRS port associated with a first PTRS port for PUSCH transmissions to the first TRP (TRP 1) using the first PTRS-DMRS association field (step 1206). If the maximum number of PTRS ports is 2, the UE 612 also determines a second DMRS port associated with a second PTRS port for the PUSCH transmissions to the first TRP using the first PTRS-DMRS association field (step 1208). The UE 612 also determines a third DMRS port associated with a third PTRS port for PUSCH transmissions to the second TRP (TRP 2) using the second PTRS-DMRS association field (step 1210). If the maximum number of PTRS ports is 2, the UE 612 also determines a fourth DMRS port associated with a fourth PTRS port for the PUSCH transmission to the second TRP using the second PTRS-DMRS association field (step 1212). The UE 612 transmits PUSCHs to the first TRP (TRP 1) with the first PTRS port and, if applicable, the second PTRS port (step 1214). The UE 612 transmits PUSCHs to the second TRP (TRP 2) with the third PTRS port and, if applicable, the fourth PTRS port (step 1216).

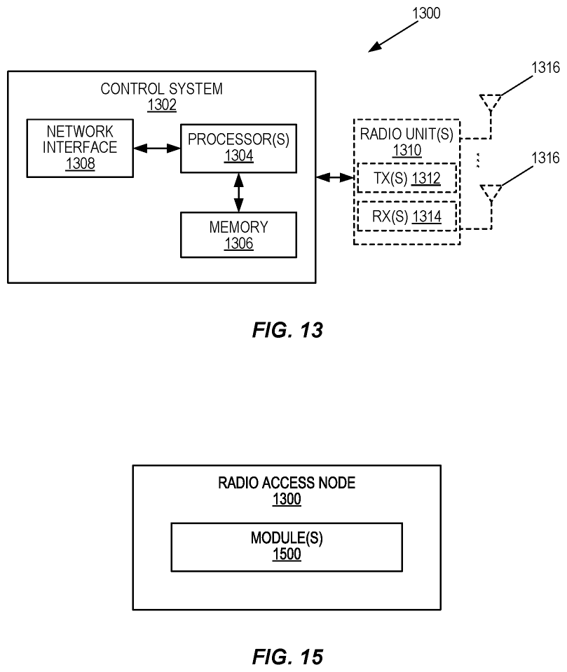

FIG. 13 is a schematic block diagram of a radio access node 1300 according to some embodiments of the present disclosure. Optional features are represented by dashed boxes. The radio access node 1300 may be, for example, a base station 602 or 606 or a network node that implements all or part of the functionality of the base station 602 or gNB as described herein or a TRP or a network node that implements at least part of the functionality of a TRP as described herein. As illustrated, the radio access node 1300 includes a control system 1302 that includes one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. In addition, the radio access node 1300 may include one or more radio units 1310 that each includes one or more transmitters 1312 and one or more receivers 1314 coupled to one or more antennas 1316. The radio units 1310 may be referred to or be part of radio interface circuitry. In some embodiments, the radio unit(s) 1310 is external to the control system 1302 and connected to the control system 1302 via, e.g., a wired connection (e.g., an optical cable). However, in some other embodiments, the radio unit(s) 1310 and potentially the antenna(s) 1316 are integrated together with the control system 1302. The one or more processors 1304 operate to provide one or more functions of the radio access node 1300 as described herein (e.g., one or more functions of a base station 602 or 606 or gNB as described herein or one or more functions of a TRP or a network node that implements at least part of the functionality of a TRP as described herein). In some embodiments, the function(s) are implemented in software that is stored, e.g., in the memory 1306 and executed by the one or more processors 1304.

FIG. 14 is a schematic block diagram that illustrates a virtualized embodiment of the radio access node 1300 according to some embodiments of the present disclosure. This discussion is equally applicable to other types of network nodes. Further, other types of network nodes may have similar virtualized architectures. Again, optional features are represented by dashed boxes. As used herein, a “virtualized” radio access node is an implementation of the radio access node 1300 in which at least a portion of the functionality of the radio access node 1300 is implemented as a virtual component(s) (e.g., via a virtual machine(s) executing on a physical processing node(s) in a network(s)). As illustrated, in this example, the radio access node 1300 may include the control system 1302 and/or the one or more radio units 1310, as described above. The control system 1302 may be connected to the radio unit(s) 1310 via, for example, an optical cable or the like. The radio access node 1300 includes one or more processing nodes 1400 coupled to or included as part of a network(s) 1402. If present, the control system 1302 or the radio unit(s) are connected to the processing node(s) 1400 via the network 1402. Each processing node 1400 includes one or more processors 1404 (e.g., CPUs, ASICs, FPGAs, and/or the like), memory 1406, and a network interface 1408.

In this example, functions 1410 of the radio access node 1300 described herein (e.g., one or more functions of a base station 602 or 606 or gNB as described herein or one or more functions of a TRP or a network node that implements at least part of the functionality of a TRP as described herein) are implemented at the one or more processing nodes 1400 or distributed across the one or more processing nodes 1400 and the control system 1302 and/or the radio unit(s) 1310 in any desired manner. In some particular embodiments, some or all of the functions 1410 of the radio access node 1300 described herein are implemented as virtual components executed by one or more virtual machines implemented in a virtual environment(s) hosted by the processing node(s) 1400. As will be appreciated by one of ordinary skill in the art, additional signaling or communication between the processing node(s) 1400 and the control system 1302 is used in order to carry out at least some of the desired functions 1410. Notably, in some embodiments, the control system 1302 may not be included, in which case the radio unit(s) 1310 communicate directly with the processing node(s) 1400 via an appropriate network interface(s).

In some embodiments, a computer program including instructions which, when executed by at least one processor, causes the at least one processor to carry out the functionality of the radio access node 1300 or a node (e.g., a processing node 1400) implementing one or more of the functions 1410 of the radio access node 1300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the radio access node 1300 according to some other embodiments of the present disclosure. The radio access node 1300 includes one or more modules 1500, each of which is implemented in software. The module(s) 1500 provide the functionality of the radio access node 1300 described herein (e.g., one or more functions of a base station 602 or 606 or gNB as described herein or one or more functions of a TRP or a network node that implements at least part of the functionality of a TRP as described herein). This discussion is equally applicable to the processing node 1400 of FIG. 14 where the modules 1500 may be implemented at one of the processing nodes 1400 or distributed across multiple processing nodes 1400 and/or distributed across the processing node(s) 1400 and the control system 1302.

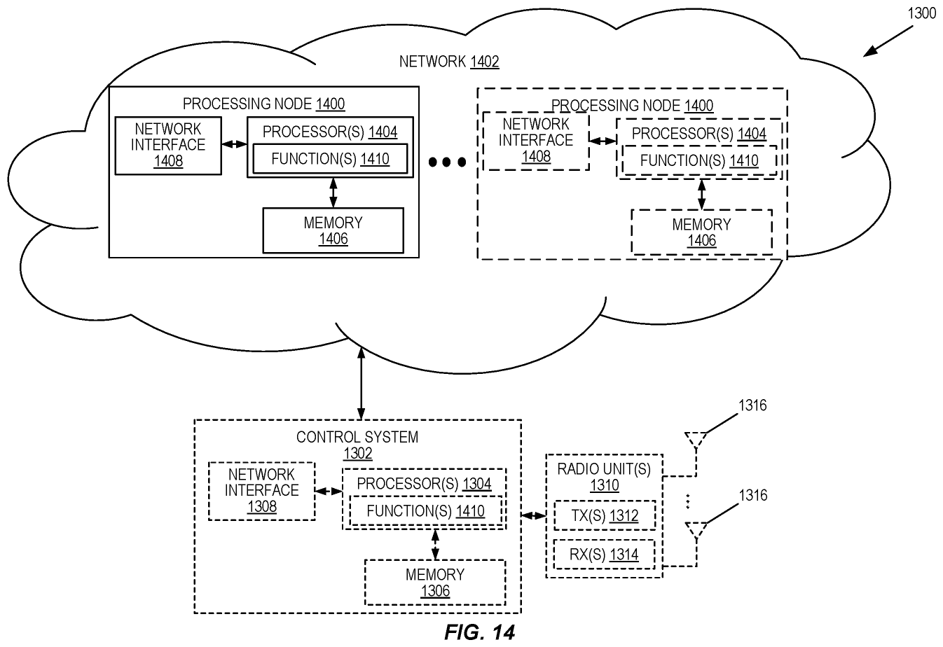

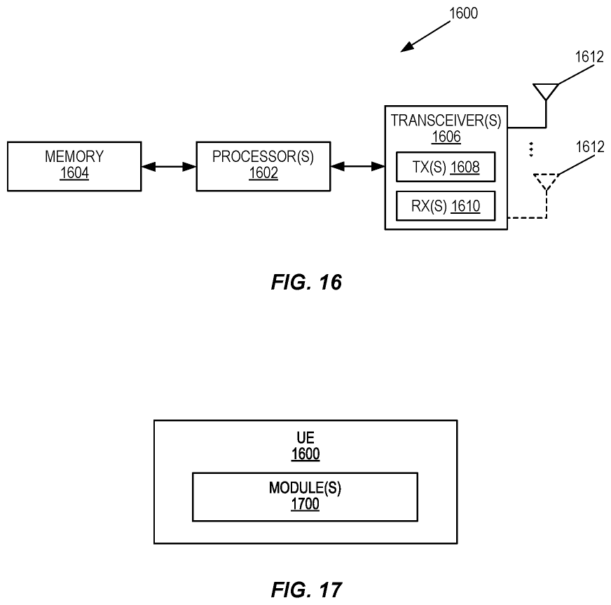

FIG. 16 is a schematic block diagram of a wireless communication device 1600 according to some embodiments of the present disclosure. The wireless communication device 1600 may be the wireless communication device 612 or UE as described herein. As illustrated, the wireless communication device 1600 includes one or more processors 1602 (e.g., CPUs, ASICs, FPGAs, and/or the like), memory 1604, and one or more transceivers 1606 each including one or more transmitters 1608 and one or more receivers 1610 coupled to one or more antennas 1612. The transceiver(s) 1606 includes radio-front end circuitry connected to the antenna(s) 1612 that is configured to condition signals communicated between the antenna(s) 1612 and the processor(s) 1602, as will be appreciated by on of ordinary skill in the art. The processors 1602 are also referred to herein as processing circuitry. The transceivers 1606 are also referred to herein as radio circuitry. In some embodiments, the functionality of the wireless communication device 1600 described above (e.g., one or more functions of a wireless communication device 612 or UE) may be fully or partially implemented in software that is, e.g., stored in the memory 1604 and executed by the processor(s) 1602. Note that the wireless communication device 1600 may include additional components not illustrated in FIG. 16 such as, e.g., one or more user interface components (e.g., an input/output interface including a display, buttons, a touch screen, a microphone, a speaker(s), and/or the like and/or any other components for allowing input of information into the wireless communication device 1600 and/or allowing output of information from the wireless communication device 1600), a power supply (e.g., a battery and associated power circuitry), etc.

In some embodiments, a computer program including instructions which, when executed by at least one processor, causes the at least one processor to carry out the functionality of the wireless communication device 1600 according to any of the embodiments described herein (e.g., one or more functions of a wireless communication device 612 or UE) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 17 is a schematic block diagram of the wireless communication device 1600 according to some other embodiments of the present disclosure. The wireless communication device 1600 includes one or more modules 1700, each of which is implemented in software. The module(s) 1700 provide the functionality of the wireless communication device 1600 described herein (e.g., one or more functions of a wireless communication device 612 or UE).

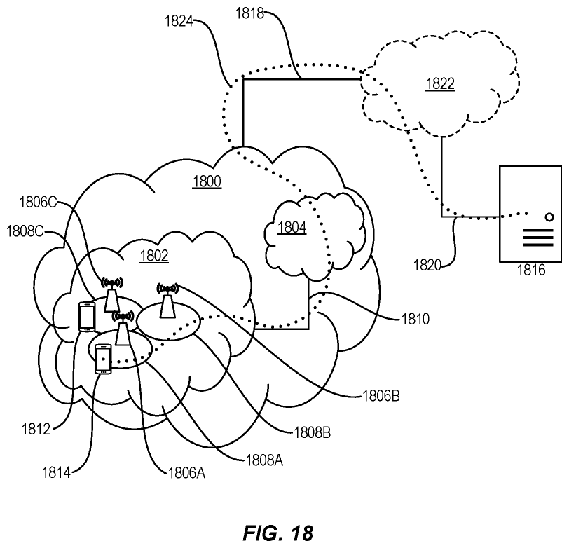

With reference to FIG. 18, in accordance with an embodiment, a communication system includes a telecommunication network 1800, such as a 3GPP-type cellular network, which comprises an access network 1802, such as a RAN, and a core network 1804. The access network 1802 comprises a plurality of base stations 1806A, 1806B, 1806C, such as Node Bs, eNBs, gNBs, or other types of wireless Access Points (APs), each defining a corresponding coverage area 1808A, 1808B, 1808C. Each base station 1806A, 1806B, 1806C is connectable to the core network 1804 over a wired or wireless connection 1810. A first UE 1812 located in coverage area 1808C is configured to wirelessly connect to, or be paged by, the corresponding base station 1806C. A second UE 1814 in coverage area 1808A is wirelessly connectable to the corresponding base station 1806A. While a plurality of UEs 1812, 1814 are illustrated in this example, the disclosed embodiments are equally applicable to a situation where a sole UE is in the coverage area or where a sole UE is connecting to the corresponding base station 1806.

The telecommunication network 1800 is itself connected to a host computer 1816, which may be embodied in the hardware and/or software of a standalone server, a cloud-implemented server, a distributed server, or as processing resources in a server farm. The host computer 1816 may be under the ownership or control of a service provider, or may be operated by the service provider or on behalf of the service provider. Connections 1818 and 1820 between the telecommunication network 1800 and the host computer 1816 may extend directly from the core network 1804 to the host computer 1816 or may go via an optional intermediate network 1822. The intermediate network 1822 may be one of, or a combination of more than one of, a public, private, or hosted network; the intermediate network 1822, if any, may be a backbone network or the Internet; in particular, the intermediate network 1822 may comprise two or more sub-networks (not shown).

The communication system of FIG. 18 as a whole enables connectivity between the connected UEs 1812, 1814 and the host computer 1816. The connectivity may be described as an Over-the-Top (OTT) connection 1824. The host computer 1816 and the connected UEs 1812, 1814 are configured to communicate data and/or signaling via the OTT connection 1824, using the access network 1802, the core network 1804, any intermediate network 1822, and possible further infrastructure (not shown) as intermediaries. The OTT connection 1824 may be transparent in the sense that the participating communication devices through which the OTT connection 1824 passes are unaware of routing of uplink and downlink communications. For example, the base station 1806 may not or need not be informed about the past routing of an incoming downlink communication with data originating from the host computer 1816 to be forwarded (e.g., handed over) to a connected UE 1812. Similarly, the base station 1806 need not be aware of the future routing of an outgoing uplink communication originating from the UE 1812 towards the host computer 1816.

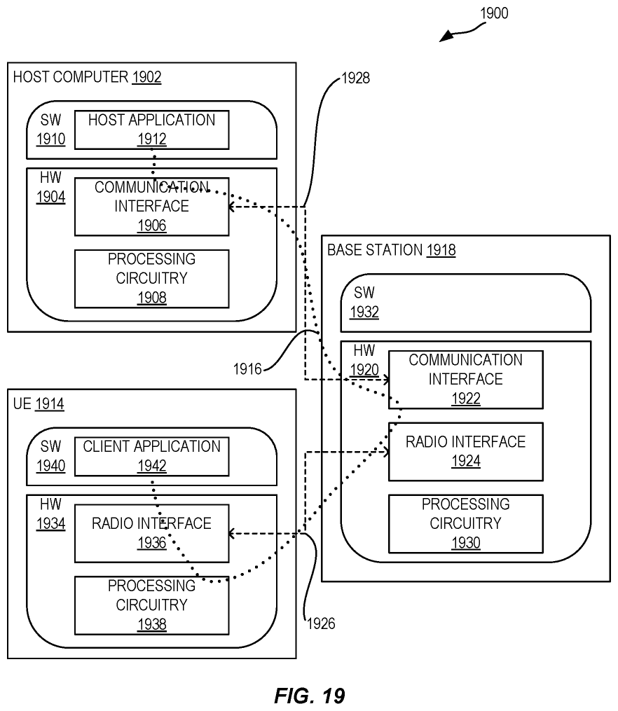

Example implementations, in accordance with an embodiment, of the UE, base station, and host computer discussed in the preceding paragraphs will now be described with reference to FIG. 19. In a communication system 1900, a host computer 1902 comprises hardware 1904 including a communication interface 1906 configured to set up and maintain a wired or wireless connection with an interface of a different communication device of the communication system 1900. The host computer 1902 further comprises processing circuitry 1908, which may have storage and/or processing capabilities. In particular, the processing circuitry 1908 may comprise one or more programmable processors, ASICs, FPGAs, or combinations of these (not shown) adapted to execute instructions. The host computer 1902 further comprises software 1910, which is stored in or accessible by the host computer 1902 and executable by the processing circuitry 1908. The software 1910 includes a host application 1912. The host application 1912 may be operable to provide a service to a remote user, such as a UE 1914 connecting via an OTT connection 1916 terminating at the UE 1914 and the host computer 1902. In providing the service to the remote user, the host application 1912 may provide user data which is transmitted using the OTT connection 1916. The communication system 1900 further includes a base station 1918

provided in a telecommunication system and comprising hardware 1920 enabling it to communicate with the host computer 1902 and with the UE 1914. The hardware 1920 may include a communication interface 1922 for setting up and maintaining a wired or wireless connection with an interface of a different communication device of the communication system 1900, as well as a radio interface 1924 for setting up and maintaining at least a wireless connection 1926 with the UE 1914 located in a coverage area (not shown in FIG. 19) served by the base station 1918. The communication interface 1922 may be configured to facilitate a connection 1928 to the host computer 1902. The connection 1928 may be direct or it may pass through a core network (not shown in FIG. 19) of the telecommunication system and/or through one or more intermediate networks outside the telecommunication system. In the embodiment shown, the hardware 1920 of the base station 1918 further includes processing circuitry 1930, which may comprise one or more programmable processors, ASICs, FPGAs, or combinations of these (not shown) adapted to execute instructions. The base station 1918 further has software 1932 stored internally or accessible via an external connection.

The communication system 1900 further includes the UE 1914 already referred to. The UE's 1914 hardware 1934 may include a radio interface 1936 configured to set up and maintain a wireless connection 1926 with a base station serving a coverage area in which the UE 1914 is currently located. The hardware 1934 of the UE 1914 further includes processing circuitry 1938, which may comprise one or more programmable processors, ASICs, FPGAs, or combinations of these (not shown) adapted to execute instructions. The UE 1914 further comprises software 1940, which is stored in or accessible by the UE 1914 and executable by the processing circuitry 1938. The software 1940 includes a client application 1942. The client application 1942 may be operable to provide a service to a human or non-human user via the UE 1914, with the support of the host computer 1902. In the host computer 1902, the executing host application 1912 may communicate with the executing client application 1942 via the OTT connection 1916 terminating at the UE 1914 and the host computer 1902. In providing the service to the user, the client application 1942 may receive request data from the host application 1912 and provide user data in response to the request data. The OTT connection 1916 may transfer both the request data and the user data. The client application 1942 may interact with the user to generate the user data that it provides.

It is noted that the host computer 1902, the base station 1918, and the UE 1914 illustrated in FIG. 19 may be similar or identical to the host computer 1816, one of the base stations 1806A, 1806B, 1806C, and one of the UEs 1812, 1814 of FIG. 18, respectively. This is to say, the inner workings of these entities may be as shown in FIG. 19 and independently, the surrounding network topology may be that of FIG. 18.

In FIG. 19, the OTT connection 1916 has been drawn abstractly to illustrate the communication between the host computer 1902 and the UE 1914 via the base station 1918 without explicit reference to any intermediary devices and the precise routing of messages via these devices. The network infrastructure may determine the routing, which may be configured to hide from the UE 1914 or from the service provider operating the host computer 1902, or both. While the OTT connection 1916 is active, the network infrastructure may further take decisions by which it dynamically changes the routing (e.g., on the basis of load balancing consideration or reconfiguration of the network).

The wireless connection 1926 between the UE 1914 and the base station 1918 is in accordance with the teachings of the embodiments described throughout this disclosure. One or more of the various embodiments improve the performance of OTT services provided to the UE 1914 using the OTT connection 1916, in which the wireless connection 1926 forms the last segment.

A measurement procedure may be provided for the purpose of monitoring data rate, latency, and other factors on which the one or more embodiments improve. There may further be an optional network functionality for reconfiguring the OTT connection 1916 between the host computer 1902 and the UE 1914, in response to variations in the measurement results. The measurement procedure and/or the network functionality for reconfiguring the OTT connection 1916 may be implemented in the software 1910 and the hardware 1904 of the host computer 1902 or in the software 1940 and the hardware 1934 of the UE 1914, or both. In some embodiments, sensors (not shown) may be deployed in or in association with communication devices through which the OTT connection 1916 passes; the sensors may participate in the measurement procedure by supplying values of the monitored quantities exemplified above, or supplying values of other physical quantities from which the software 1910, 1940 may compute or estimate the monitored quantities. The reconfiguring of the OTT connection 1916 may include message format, retransmission settings, preferred routing, etc.; the reconfiguring need not affect the base station 1918, and it may be unknown or imperceptible to the base station 1918. Such procedures and functionalities may be known and practiced in the art. In certain embodiments, measurements may involve proprietary UE signaling facilitating the host computer 1902's measurements of throughput, propagation times, latency, and the like. The measurements may be implemented in that the software 1910 and 1940 causes messages to be transmitted, in particular empty or ‘dummy’ messages, using the OTT connection 1916 while it monitors propagation times, errors, etc.

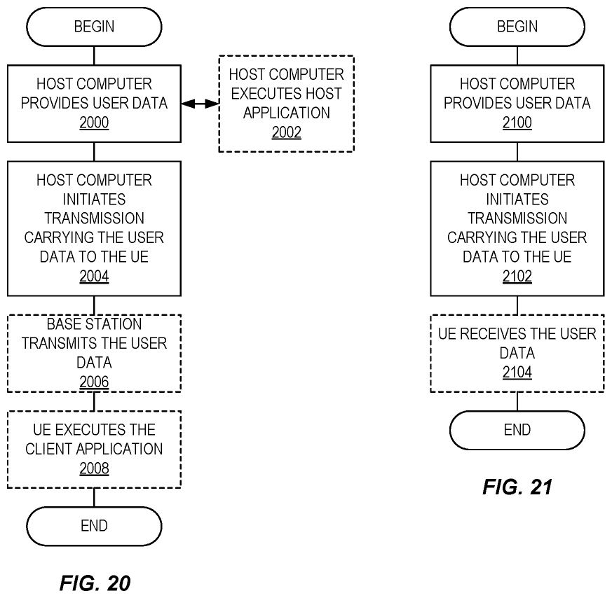

FIG. 20 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 20 will be included in this section. In step 2000, the host computer provides user data. In sub-step 2002 (which may be optional) of step 2000, the host computer provides the user data by executing a host application. In step 2004, the host computer initiates a transmission carrying the user data to the UE. In step 2006 (which may be optional), the base station transmits to the UE the user data which was carried in the transmission that the host computer initiated, in accordance with the teachings of the embodiments described throughout this disclosure. In step 2008 (which may also be optional), the UE executes a client application associated with the host application executed by the host computer.

FIG. 21 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 21 will be included in this section. In step 2100 of the method, the host computer provides user data. In an optional sub-step (not shown) the host computer provides the user data by executing a host application. In step 2102, the host computer initiates a transmission carrying the user data to the UE. The transmission may pass via the base station, in accordance with the teachings of the embodiments described throughout this disclosure. In step 2104 (which may be optional), the UE receives the user data carried in the transmission.

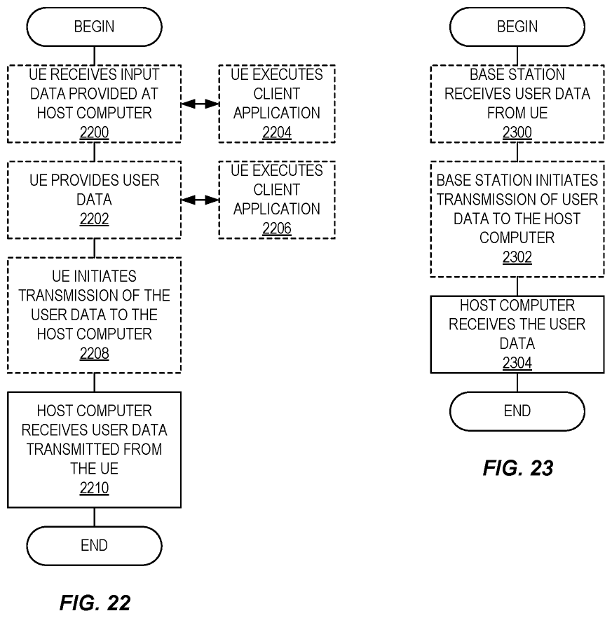

FIG. 22 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 22 will be included in this section. In step 2200 (which may be optional), the UE receives input data provided by the host computer. Additionally or alternatively, in step 2202, the UE provides user data. In sub-step 2204 (which may be optional) of step 2200, the UE provides the user data by executing a client application. In sub-step 2206 (which may be optional) of step 2202, the UE executes a client application which provides the user data in reaction to the received input data provided by the host computer. In providing the user data, the executed client application may further consider user input received from the user. Regardless of the specific manner in which the user data was provided, the UE initiates, in sub-step 2208 (which may be optional), transmission of the user data to the host computer. In step 2210 of the method, the host computer receives the user data transmitted from the UE, in accordance with the teachings of the embodiments described throughout this disclosure.

FIG. 23 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 23 will be included in this section. In step 2300 (which may be optional), in accordance with the teachings of the embodiments described throughout this disclosure, the base station receives user data from the UE. In step 2302 (which may be optional), the base station initiates transmission of the received user data to the host computer. In step 2304 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless communication device comprising:
receiving (1104; 1204) downlink control information, DCI, from a base station, wherein:
   the DCI schedules physical uplink shared channel, PUSCH, repetitions to two (or more) transmission/reception points, TRPs; and
   the DCI comprises:
      an antenna ports field; and
      at least one PTRS-DMRS association field;
determining (1106-1108; 1206-1208) at least one DMRS port associated with at least one PTRS port for PUSCH transmissions to a first TRP based on a value of the at least one PTRS-DMRS association field comprised in the DCI;
determining (1110-1112; 1210-1212) at least one DMRS port associated with at least one PTRS port for PUSCH transmissions to a second TRP based on the value of the at least one PTRS-DMRS association field comprised in the DCI;
transmitting (1114; 1214) a PUSCH(s) to the first TRP with the at least one PTRS port for PUSCH transmissions to the first TRP; and
transmitting (1116; 1216) a PUSCH(s) to the second TRP with the at least one PTRS port for PUSCH transmissions to the first TRP.

Embodiment 2: The method of embodiment 1 wherein the at least one PTRS-DMRS association field is a single PTRS-DMRS association field.

Embodiment 3: The method of embodiment 2 wherein the single PTRS-DMRS association field is a 2-bit field.

Embodiment 4: The method of embodiment 2 or 3 wherein:
determining (1106-1108) the at least one DMRS port associated with the at least one PTRS port for PUSCH transmissions to the first TRP comprises determining (1106) a first DMRS port associated with a first PTRS port for PUSCH transmissions to the first TRP based on the value of the single PTRS-DMRS association field comprised in the DCI;
determining (1110-1112) the at least one DMRS port associated with the at least one PTRS port for PUSCH transmissions to the second TRP comprises determining (1110) a second DMRS port associated with a second PTRS port for PUSCH transmissions to the second TRP based on the value of the single PTRS-DMRS association field comprised in the DCI;
transmitting (1114) the PUSCH(s) to the first TRP comprises transmitting (1114) the PUSCH(s) to the first TRP with the first PTRS port associated to the first DMRS port; and
transmitting (1116) the PUSCH(s) to the second TRP comprises transmitting (1116) the PUSCH(s) to the second TRP with the second PTRS port associated to the second DMRS port.

Embodiment 5: The method of embodiment 4 wherein:
the single PTRS-DMRS association field is a 2-bit field;
the DCI is for non-codebook based PUSCH transmission and further comprises a first SRI field and a second SRI field;
a most-significant bit, MSB, of the single PTRS-DMRS association field is associated with the first SRI field;
a least-significant bit, LSB, of the single PTRS-DMRS association field is associated with the second SRI field.

Embodiment 6: The method of embodiment 4 wherein:
the single PTRS-DMRS association field is a 2-bit field;
the DCI is for codebook based PUSCH transmission and further comprises a first TPMI field and a second TPMI field;
a most-significant bit, MSB, of the single PTRS-DMRS association field is associated with the first TPMI field;
a least-significant bit, LSB, of the single PTRS-DMRS association field is associated with the second TPMI field.

Embodiment 7: The method of embodiment 5 or 6 wherein:
a maximum rank for PUSCH transmission is up to either 2 or 4;
the MSB of the single PTRS-DMRS association field indicates one of a first and second DMRS ports indicated in the antenna ports field to be associated with first PTRS port for the PUSCH transmissions to the first TRP; and
the LSB of the single PTRS-DMRS association field indicates one of the first and second DMRS ports indicated in the antenna ports field to be associated with the second PTRS port for the PUSCH transmissions to the second TRP.

Embodiment 8: The method of embodiment 5 or 6 wherein:
a rank 3 or 4 is indicated in the DCI;
the MSB of the single PTRS-DMRS association field indicates one of a first and third DMRS ports indicated in the antenna ports field to be associated with first PTRS port for the PUSCH transmissions to the first TRP; and
the LSB of the single PTRS-DMRS association field indicates one of the first and third DMRS ports indicated in the antenna ports field to be associated with the second PTRS port for the PUSCH transmissions to the second TRP.

Embodiment 9: The method of embodiment 2 or 3 wherein the wireless communication device (612) is configured with two PTRS ports per TRP, and:
determining (1106-1108) the at least one DMRS port associated with the at least one PTRS port for PUSCH transmissions to the first TRP comprises:
   determining (1106) a first DMRS port associated with a first PTRS port for PUSCH transmissions to the first TRP based on the value of the single PTRS-DMRS association field comprised in the DCI;
   determining (1108) a second DMRS port associated with a second PTRS port for PUSCH transmission to the first TRP based on the value of the single PTRS-DMRS association field comprised in the DCI; and
determining (1110-1112) the at least one DMRS port associated with the at least one PTRS port for PUSCH transmissions to the second TRP comprises:
   determining (1110) a third DMRS port associated with a third PTRS port for PUSCH transmissions to the second TRP based on the value of the single PTRS-DMRS association field comprised in the DCI; and
   determining (1112) a fourth DMRS port associated with a fourth PTRS port for PUSCH transmission to the second TRP based on the value of the single PTRS-DMRS association field comprised in the DCI; and
transmitting (1114) the PUSCH(s) to the first TRP comprises transmitting (1114) the PUSCH(s) to the first TRP with the first PTRS port associated to the first DMRS port and the second PTRS port associated to the second DMRS port; and
transmitting (1116) the PUSCH(s) to the second TRP comprises transmitting (1116) the PUSCH(s) to the second TRP with the third PTRS port associated to the third DMRS port and the fourth PTRS port associated to the fourth DMRS port.

Embodiment 10: The method of embodiment 9 wherein:
the single PTRS-DMRS association field is a 2-bit field;
a most-significant bit, MSB, of the single PTRS-DMRS association field is associated with the first and third PTRS ports;
a least-significant bit, LSB, of the single PTRS-DMRS association field is associated with the second and fourth PTRS ports.

Embodiment 11: The method of embodiment 9 wherein:
the single PTRS-DMRS association field is a 2-bit field;
the single PTRS-DMRS association field is applied to only the first TRP or only the second TRP.

Embodiment 12: The method of embodiment 9 wherein a PTRS-DMRS association for the other TRP is predefined.

Embodiment 13: The method of embodiment 9 wherein:
the single PTRS-DMRS association field is a 2-bit field;
a most-significant bit, MSB, of the single PTRS-DMRS association field indicates:
   the first DMRS port associated to the first PTRS port from among a first DMRS port group; and
   the third DMRS port associated to the third PTRS port from among a second DMRS port group; and
a least-significant bit, LSB, of the single PTRS-DMRS association field indicates:
   the second DMRS port associated to the second PTRS port from among the first DMRS port group; and
   the fourth DMRS port associated to the fourth PTRS port from among the second DMRS port group.

Embodiment 14: The method of embodiment 13 wherein the first DMRS port is associated to a first PUSCH or SRS port group, and the second DMRS port is associated to a second PUSCH or SRS port group.

Embodiment 15: The method of embodiment 1 wherein the at least one PTRS-DMRS association field comprises a first PTRS-DMRS association field and a second PTRS-DMRS association field.

Embodiment 16: The method of embodiment 15 wherein each of the first and second PTRS-DMRS association fields is a 2-bit field.

Embodiment 17: The method of embodiment 15 or 16 wherein:
determining (1206-1208) the at least one DMRS port associated with the at least one PTRS port for PUSCH transmissions to the first TRP comprises determining (1206) a first DMRS port associated with a first PTRS port for PUSCH transmissions to the first TRP based on a value of the first PTRS-DMRS association field comprised in the DCI;
determining (1210-1212) the at least one DMRS port associated with the at least one PTRS port for PUSCH transmissions to the second TRP comprises determining (1210) a second DMRS port associated with a second PTRS port for PUSCH transmissions to the second TRP based on a value of the second PTRS-DMRS association field comprised in the DCI;
transmitting (1214) the PUSCH(s) to the first TRP comprises transmitting (1214) the PUSCH(s) to the first TRP with the first PTRS port associated to the first DMRS port; and
transmitting (1216) the PUSCH(s) to the second TRP comprises transmitting (1216) the PUSCH(s) to the second TRP with the second PTRS port associated to the second DMRS port.

Embodiment 18: The method of embodiment 15 or 16 wherein the wireless communication device (612) is configured with two PTRS ports per TRP, and:
determining (1206-1208) the at least one DMRS port associated with the at least one PTRS port for PUSCH transmissions to the first TRP comprises:
   determining (1206) a first DMRS port associated with a first PTRS port for PUSCH transmissions to the first TRP based on a value of the first PTRS-DMRS association field comprised in the DCI; and
   determining (1208) a second DMRS port associated with a second PTRS port for PUSCH transmission to the first TRP based on the value of the first PTRS-DMRS association field comprised in the DCI;
determining (1210-1212) the at least one DMRS port associated with the at least one PTRS port for PUSCH transmissions to the second TRP comprises:
   determining (1210) a third DMRS port associated with a third PTRS port for PUSCH transmissions to the second TRP based on a value of the second PTRS-DMRS association field comprised in the DCI; and
   determining (1212) a fourth DMRS port associated with a fourth PTRS port for PUSCH transmission to the second TRP based on the value of the second PTRS-DMRS association field comprised in the DCI; and
transmitting (1214) the PUSCH(s) to the first TRP comprises transmitting (1114) the PUSCH(s) to the first TRP with the first PTRS port associated to the first DMRS port and the second PTRS port associated to the second DMRS port; and
transmitting (1216) the PUSCH(s) to the second TRP comprises transmitting (1116) the PUSCH(s) to the second TRP with the third PTRS port associated to the third DMRS port and the fourth PTRS port associated to the fourth DMRS port.

Embodiment 19: The method of any of embodiments 1 to 18 wherein a PTRS to PUSCH power radio is configured per TRP.

Embodiment 20: The method of any of the previous embodiments, further comprising: providing user data; and forwarding the user data to a host computer via the transmission to the base station.

### Group B Embodiments

Embodiment 21: A method performed by a base station comprising:
sending (1104; 1204) downlink control information, DCI, to a wireless communication device (612), wherein:
   the DCI schedules physical uplink shared channel, PUSCH, repetitions to two (or more) transmission/reception points, TRPs; and
   the DCI comprises:
      an antenna ports field; and
      at least one PTRS-DMRS association field;
wherein:
   at least one DMRS port associated with at least one PTRS port for PUSCH transmissions to a first TRP is based on a value of the at least one PTRS-DMRS association field comprised in the DCI; and
   at least one DMRS port associated with at least one PTRS port for PUSCH transmissions to a second TRP is based on the value of the at least one PTRS-DMRS association field comprised in the DCI.

Embodiment 22: The method of embodiment 21 wherein the at least one PTRS-DMRS association field is a single PTRS-DMRS association field.

Embodiment 23: The method of embodiment 22 wherein the single PTRS-DMRS association field is a 2-bit field.

Embodiment 24: The method of embodiment 22 or 23 wherein:
a first DMRS port associated with a first PTRS port for PUSCH transmissions to the first TRP is based on the value of the single PTRS-DMRS association field comprised in the DCI;
a second DMRS port associated with a second PTRS port for PUSCH transmissions to the second TRP is based on the value of the single PTRS-DMRS association field comprised in the DCI.

Embodiment 25: The method of embodiment 24 wherein:
the single PTRS-DMRS association field is a 2-bit field;
the DCI is for non-codebook based PUSCH transmission and further comprises a first SRI field and a second SRI field;
a most-significant bit, MSB, of the single PTRS-DMRS association field is associated with the first SRI field;
a least-significant bit, LSB, of the single PTRS-DMRS association field is associated with the second SRI field.

Embodiment 26: The method of embodiment 24 wherein:
the single PTRS-DMRS association field is a 2-bit field;
the DCI is for codebook based PUSCH transmission and further comprises a first TPMI field and a second TPMI field;
a most-significant bit, MSB, of the single PTRS-DMRS association field is associated with the first TPMI field;
a least-significant bit, LSB, of the single PTRS-DMRS association field is associated with the second TPMI field.

Embodiment 27: The method of embodiment 25 or 26 wherein:
a maximum rank for PUSCH transmission is up to either 2 or 4;
the MSB of the single PTRS-DMRS association field indicates one of a first and second DMRS ports indicated in the antenna ports field to be associated with first PTRS port for the PUSCH transmissions to the first TRP; and
the LSB of the single PTRS-DMRS association field indicates one of the first and second DMRS ports indicated in the antenna ports field to be associated with the second PTRS port for the PUSCH transmissions to the second TRP.

Embodiment 28: The method of embodiment 25 or 26 wherein: a rank 3 or 4 is indicated in the DCI;
the MSB of the single PTRS-DMRS association field indicates one of a first and
third DMRS ports indicated in the antenna ports field to be associated with first PTRS port for the PUSCH transmissions to the first TRP; and
the LSB of the single PTRS-DMRS association field indicates one of the first and third DMRS ports indicated in the antenna ports field to be associated with the second PTRS port for the PUSCH transmissions to the second TRP.

Embodiment 29: The method of embodiment 22 or 23 wherein the wireless communication device (612) is configured with two PTRS ports per TRP, and:
the at least one DMRS port associated with the at least one PTRS port for PUSCH transmissions to the first TRP comprises:
   a first DMRS port associated with a first PTRS port for PUSCH transmissions to the first TRP based on the value of the single PTRS-DMRS association field comprised in the DCI;
   a second DMRS port associated with a second PTRS port for PUSCH transmission to the first TRP based on the value of the single PTRS-DMRS association field comprised in the DCI; and
the at least one DMRS port associated with the at least one PTRS port for PUSCH transmissions to the second TRP comprises:
   a third DMRS port associated with a third PTRS port for PUSCH transmissions to the second TRP based on the value of the single PTRS-DMRS association field comprised in the DCI; and
   a fourth DMRS port associated with a fourth PTRS port for PUSCH transmission to the second TRP based on the value of the single PTRS-DMRS association field comprised in the DCI.

Embodiment 30: The method of embodiment 29 wherein:
the single PTRS-DMRS association field is a 2-bit field;
a most-significant bit, MSB, of the single PTRS-DMRS association field is associated with the first and third PTRS ports;
a least-significant bit, LSB, of the single PTRS-DMRS association field is associated with the second and fourth PTRS ports.

Embodiment 31: The method of embodiment 29 wherein:
the single PTRS-DMRS association field is a 2-bit field;
the single PTRS-DMRS association field is applied to only the first TRP or only the second TRP.

Embodiment 32: The method of embodiment 31 wherein a PTRS-DMRS association for the other TRP is predefined.

Embodiment 33: The method of embodiment 29 wherein:
the single PTRS-DMRS association field is a 2-bit field;
a most-significant bit, MSB, of the single PTRS-DMRS association field indicates:
   the first DMRS port associated to the first PTRS port from among a first DMRS port group; and
   the third DMRS port associated to the third PTRS port from among a second DMRS port group; and
a least-significant bit, LSB, of the single PTRS-DMRS association field indicates:
   the second DMRS port associated to the second PTRS port from among the first DMRS port group; and
   the fourth DMRS port associated to the fourth PTRS port from among the second DMRS port group.

Embodiment 34: The method of embodiment 33 wherein the first DMRS port is associated to a first PUSCH or SRS port group, and the second DMRS port is associated to a second PUSCH or SRS port group.

Embodiment 35: The method of embodiment 21 wherein the at least one PTRS-DMRS association field comprises a first PTRS-DMRS association field and a second PTRS-DMRS association field.

Embodiment 36: The method of embodiment 35 wherein each of the first and second PTRS-DMRS association fields is a 2-bit field.

Embodiment 37: The method of embodiment 35 or 36 wherein:
the at least one DMRS port associated with the at least one PTRS port for PUSCH transmissions to the first TRP comprises a first DMRS port associated with a first PTRS port for PUSCH transmissions to the first TRP based on a value of the first PTRS-DMRS association field comprised in the DCI; and
the at least one DMRS port associated with the at least one PTRS port for PUSCH transmissions to the second TRP comprises a second DMRS port associated with a second PTRS port for PUSCH transmissions to the second TRP based on a value of the second PTRS-DMRS association field comprised in the DCI.

Embodiment 38: The method of embodiment 35 or 36 wherein the wireless communication device (612) is configured with two PTRS ports per TRP, and:
the at least one DMRS port associated with the at least one PTRS port for PUSCH transmissions to the first TRP comprises:
   a first DMRS port associated with a first PTRS port for PUSCH transmissions to the first TRP based on a value of the first PTRS-DMRS association field comprised in the DCI;
   a second DMRS port associated with a second PTRS port for PUSCH transmission to the first TRP based on the value of the first PTRS-DMRS association field comprised in the DCI; and
the at least one DMRS port associated with the at least one PTRS port for PUSCH transmissions to the second TRP comprises:
   a third DMRS port associated with a third PTRS port for PUSCH transmissions to the second TRP based on a value of the second PTRS-DMRS association field comprised in the DCI; and
   a fourth DMRS port associated with a fourth PTRS port for PUSCH transmission to the second TRP based on the value of the second PTRS-DMRS association field comprised in the DCI.

Embodiment 39: The method of any of embodiments 21 to 38 wherein a PTRS to PUSCH power radio is configured per TRP.

Embodiment 40: The method of any of the previous embodiments, further comprising: obtaining user data; and forwarding the user data to a host computer or a wireless communication device.

### Group C Embodiments

Embodiment 41: A wireless communication device comprising: processing circuitry configured to perform any of the steps of any of the Group A embodiments; and power supply circuitry configured to supply power to the wireless communication device.

Embodiment 42: A base station comprising: processing circuitry configured to perform any of the steps of any of the Group B embodiments; and power supply circuitry configured to supply power to the base station.

Embodiment 43: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 44: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 45: The communication system of the previous embodiment further including the base station.

Embodiment 46: The communication system of the previous 2 embodiments, further including the UE, wherein the UE is configured to communicate with the base station.

Embodiment 47: The communication system of the previous 3 embodiments, wherein: the processing circuitry of the host computer is configured to execute a host application, thereby providing the user data; and the UE comprises processing circuitry configured to execute a client application associated with the host application.

Embodiment 48: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 49: The method of the previous embodiment, further comprising, at the base station, transmitting the user data.

Embodiment 50: The method of the previous 2 embodiments, wherein the user data is provided at the host computer by executing a host application, the method further comprising, at the UE, executing a client application associated with the host application.

Embodiment 51: A User Equipment, UE, configured to communicate with a base station, the UE comprising a radio interface and processing circuitry configured to perform the method of the previous 3 embodiments.

Embodiment 52: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 53: The communication system of the previous embodiment, wherein the cellular network further includes a base station configured to communicate with the UE.

Embodiment 54: The communication system of the previous 2 embodiments, wherein: the processing circuitry of the host computer is configured to execute a host application, thereby providing the user data; and the UE's processing circuitry is configured to execute a client application associated with the host application.

Embodiment 55: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 56: The method of the previous embodiment, further comprising at the UE, receiving the user data from the base station.

Embodiment 57: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 58: The communication system of the previous embodiment, further including the UE.

Embodiment 59: The communication system of the previous 2 embodiments, further including the base station, wherein the base station comprises a radio interface configured to communicate with the UE and a communication interface configured to forward to the host computer the user data carried by a transmission from the UE to the base station.

Embodiment 60: The communication system of the previous 3 embodiments, wherein: the processing circuitry of the host computer is configured to execute a host application; and the UE's processing circuitry is configured to execute a client application associated with the host application, thereby providing the user data.

Embodiment 61: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 62: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 63: The method of the previous embodiment, further comprising, at the UE, providing the user data to the base station.

Embodiment 64: The method of the previous 2 embodiments, further comprising: at the UE, executing a client application, thereby providing the user data to be transmitted; and at the host computer, executing a host application associated with the client application.

Embodiment 65: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 66: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 67: The communication system of the previous embodiment further including the base station.

Embodiment 68: The communication system of the previous 2 embodiments, further including the UE, wherein the UE is configured to communicate with the base station.

Embodiment 69: The communication system of the previous 3 embodiments, wherein: the processing circuitry of the host computer is configured to execute a host application; and the UE is configured to execute a client application associated with the host application, thereby providing the user data to be received by the host computer.

Embodiment 70: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 71: The method of the previous embodiment, further comprising at the base station, receiving the user data from the UE.

Embodiment 72: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1-42. (canceled)

43. A method performed by a wireless communication device comprising:
receiving Downlink Control Information, DCI, from a base station, wherein:
the DCI schedules Physical Uplink Shared Channel, PUSCH, repetitions to one or two Transmission/Reception Points, TRPs, wherein the DCI is configured by the base station with a first and a second Sounding Reference Signal, SRS, Resource Sets and the PUSCH is configured by the base station with a maximum rank larger than 2; and
the DCI comprises:
an antenna ports field that indicates two or more Demodulation Reference Signal, DMRS, ports;
a first and a second SRS resource indicator, SRI, fields and/or a first and a second Transmit Precoding Matrix Indicator, TPMI, fields; and
two PTRS-DMRS association fields, a first and a second PTRS-DMRS fields, each having 2 bits;
determining, when the DCI schedules PUSCH repetitions to two TRPS, at least one of the DMRS port associated with at least one PTRS port for PUSCH transmissions to a first TRP based on the first PTRS-DMRS association field comprised in the DCI, where the first TRP is associated to the first SRS resource set;
determining, when the DCI schedules PUSCH repetitions to two TRPs at least one DMRS port associated with at least one PTRS port for PUSCH transmissions to a second TRP based on the second PTRS-DMRS association field comprised in the DCI where the second TRP is associated to the second SRS resource set;
determining, when the DCI schedules PUSCH repetitions to the first or the second TRP, at least one of the DMRS ports associated with at least one PTRS port for PUSCH transmissions to the first or the second TRP based on the first PTRS-DMRS association field if the PUSCH repetitions are associated to the first SRI field or the second PTRS-DMRS association field if the PUSCH repetitions are associated to the second SRI field;
transmitting a first PUSCH repetition to the first TRP with the at least one PTRS port for PUSCH transmissions to the first TRP; and
transmitting a second PUSCH repetition to the second TRP with the at least one PTRS port for PUSCH transmissions to the second TRP;
wherein either:
the first PTRS-DMRS association field is associated with the first SRI field in the DCI and the second TRP is associated with the second PTRS-DMRS association field is associated with the second SRI field in the DCI; or
the first PTRS-DMRS association field is associated with a first SRS resource set or the second PTRS-DMRS association field is associated with a second SRS resource set, where the first SRS resource set is associated with the first SRI field in the DCI and the second SRS resource set is associated with the second SRI field in the DCI; or
the first PTRS-DMRS association field is associated with the first TPMI field of the DCI or the second PTRS-DMRS association field is associated with the second TPMI field of the DCI.

44. The method of claim 43, wherein:
the DCI comprises the two PTRS-DMRS association fields, the first and the second PTRS-DMRS fields, each having 2 bits;
the first PTRS-DMRS association field is associated with the first TRP; and
the second PTRS-DMRS association field is associated with the second TRP;
wherein the first TRP is associated with the first SRI field in the DCI and the second TRP is associated with the second SRI field in the DCI.

45. The method of claim 43, wherein:
the DCI comprises the two PTRS-DMRS association fields, the first and the second PTRS-DMRS fields, each having 2 bits;
the first PTRS-DMRS association field is associated with the first SRS resource set associated to the first TRP; and
the second PTRS-DMRS association field is associated with the second SRS resource set associated to the second TRP;
wherein the first SRS resource set is associated with the first SRI field in the DCI and the second SRS resource set is associated with the second SRI field in the DCI.

46. The method of claim 43, wherein:
the DCI comprises the two PTRS-DMRS association fields, the first and the second PTRS-DMRS fields, each having 2 bits;
the DCI is for non-codebook based PUSCH transmission and further comprises a first SRI field and a second SRI field;
the first PTRS-DMRS association field is associated with the first SRI field; and
the second PTRS-DMRS association field is associated with the second SRI field.

47. The method of claim 43, wherein:
the DCI comprises the two PTRS-DMRS association fields, the first and the second PTRS-DMRS fields, each having 2 bits;
the first PTRS-DMRS association field is associated with the first TPMI field of the DCI associated to the first TRP; and
the second PTRS-DMRS association field is associated with the second TPMI field of the DCI associated to the second TRP.

48. The method of claim 43, wherein:
the DCI comprises the two PTRS-DMRS association fields, the first and the second PTRS-DMRS fields, each having 2 bits;
the DCI is for codebook based PUSCH transmission and further comprises a first TPMI field and a second TPMI field;
the first PTRS-DMRS association field is associated with the first TPMI field; and
the second PTRS-DMRS association field is associated with the second TPMI field.

49. The method of claim 43, wherein:
determining the at least one DMRS port associated with the at least one PTRS port for PUSCH transmissions to the first TRP comprises determining a first DMRS port associated with a first PTRS port for PUSCH transmissions to the first TRP based on the first PTRS-DMRS association field comprised in the DCI;
determining the at least one DMRS port associated with the at least one PTRS port for PUSCH transmissions to the second TRP comprises determining a second DMRS port associated with a second PTRS port for PUSCH transmissions to the second TRP based the second PTRS-DMRS association field comprised in the DCI;
transmitting the first PUSCH repetition to the first TRP comprises transmitting the first PUSCH repetition to the first TRP with the first PTRS port associated to the first DMRS port; and
transmitting the second PUSCH repetition to the second TRP comprises transmitting the second PUSCH repetition to the second TRP with the second PTRS port associated to the second DMRS port.

50. The method of claim 43, wherein:
the first PTRS-DMRS association field indicates one of up to four DMRS ports indicated in the antenna ports field to be associated with a first PTRS port for the PUSCH transmissions to the first TRP; and
the second PTRS-DMRS association field indicates one of up to four DMRS ports indicated in the antenna ports field to be associated with a first PTRS port for the PUSCH transmissions to the second TRP.

51. The method of claim 43, wherein the wireless communication device is configured with two PTRS ports per TRP, and:
determining the at least one DMRS port associated with the at least one PTRS port for PUSCH transmissions to the first TRP comprises:
determining a first DMRS port associated with a first PTRS port for PUSCH transmissions to the first TRP based on the value of first PTRS-DMRS association field comprised in the DCI;
determining a second DMRS port associated with a second PTRS port for PUSCH transmission to the first TRP based on the first PTRS-DMRS association field comprised in the DCI; and
determining the at least one DMRS port associated with the at least one PTRS port for PUSCH transmissions to the second TRP comprises:
determining a third DMRS port associated with a third PTRS port for PUSCH transmissions to the second TRP based on a Most Significant Bit (MSB) of the second PTRS-DMRS association field comprised in the DCI; and
determining a fourth DMRS port associated with a fourth PTRS port for PUSCH transmission to the second TRP based on the value of the second PTRS-DMRS association field comprised in the DCI;
transmitting the first PUSCH repetition to the first TRP comprises transmitting the first PUSCH repetition to the first TRP with the first PTRS port associated to the first DMRS port and the second PTRS port associated to the second DMRS port; and
transmitting the second PUSCH repetition to the second TRP comprises transmitting the second PUSCH repetition to the second TRP with the third PTRS port associated to the third DMRS port and the fourth PTRS port associated to the fourth DMRS port.

52. The method of claim 43, wherein:
the DCI comprises the two PTRS-DMRS association fields, the first and the second PTRS-DMRS fields, each having 2 bits;
the MSB of the first PTRS-DMRS association field indicates:
the first DMRS port associated to the first PTRS port from among a first DMRS port group;
a Least Significant Bit (LSB) of the first PTRS-DMRS association field indicates:
the second DMRS port associated to the second PTRS port from among a second DMRS port group;
the MSB of the second PTRS-DMRS association field indicates:
the third DMRS port associated to the third PTRS port from among the first DMRS port group;
the LSB of the second PTRS-DMRS association field indicates:
the fourth DMRS port associated to the fourth PTRS port from among the second DMRS port group.

53. The method of claim 52, wherein the first DMRS port is associated to a first PUSCH or SRS port group sharing PT-RS port 0, and the second DMRS port is associated to a second PUSCH or SRS port group sharing PT-RS port 1.

54. A wireless communication device comprising:
one or more transmitters;
one or more receivers; and
processing circuitry associated with the one or more transmitters and the one or more receivers, the processing circuitry configured to cause the wireless communication device to:
receive Downlink Control Information, DCI, from a base station, wherein:
the DCI schedules Physical Uplink Shared Channel, PUSCH, repetitions to one or two Transmission/Reception Points, TRPs, wherein the DCI is configured by the base station with a first and a second Sounding Reference Signal, SRS, Resource Sets and the PUSCH is configured by the base station with a maximum rank larger than 2; and
the DCI comprises:
an antenna ports field that indicates two or more Demodulation Reference Signal, DMRS, ports;
a first and a second SRS resource indicator, SRI, fields and/or a first and a second Transmit Precoding Matrix Indicator, TPMI, fields; and
two PTRS-DMRS association fields, a first and a second PTRS-DMRS fields, each having 2 bits;
determine, when the DCI schedules PUSCH repetitions to two TRPS, at least one of the DMRS port associated with at least one PTRS port for PUSCH transmissions to a first TRP based on either a value of the first PTRS-DMRS association field comprised in the DCI, where the first TRP is associated to the first SRS resource set;
determine, when the DCI schedules PUSCH repetitions to two TRPs at least one DMRS port associated with at least one PTRS port for PUSCH transmissions to a second TRP based on either a value of the second PTRS-DMRS association field comprised in the DCI where the second TRP is associated to the second SRS resource set;
determine, when the DCI schedules PUSCH repetitions to the first or the second TRP, at least one of the DMRS ports associated with at least one PTRS port for PUSCH transmissions to the first or the second TRP based on the first PTRS-DMRS association field if the PUSCH repetitions are associated to the first SRI field or the second PTRS-DMRS association field if the PUSCH repetitions are associated to the second SRI field;
transmit a first PUSCH repetition to the first TRP with the at least one PTRS port for PUSCH transmissions to the first TRP; and
transmit a second PUSCH repetition to the second TRP with the at least one PTRS port for PUSCH transmissions to the second TRP;
wherein either:
the first PTRS-DMRS association field is associated with the first SRI field in the DCI and the second TRP is associated with the second PTRS-DMRS association field is associated with the second SRI field in the DCI; or
the first PTRS-DMRS association field is associated with a first SRS resource set and the second PTRS-DMRS association field is associated with a second SRS resource set, where the first SRS resource set is associated with the first SRI field in the DCI and the second SRS resource set is associated with the second SRI field in the DCI; or
the first PTRS-DMRS association field is associated with the first TPMI field of the DCI and the second PTRS-DMRS association field is associated with the second TPMI field of the DCI.

55. A method performed by a wireless communication device comprising:
receiving Downlink Control Information, DCI, from a base station, wherein:
the DCI schedules Physical Uplink Shared Channel, PUSCH, repetitions to two Transmission/Reception Points, TRPs; and
the DCI comprises:
an antenna ports field that indicates two or more Demodulation Reference Signal, DMRS, ports;
a Phase Tracking Reference Signal to Demodulation Reference Signal, PTRS-DMRS, association field, the PTRS-DMRS association field being a 2-bit field;
determining at least one DMRS port associated with at least one PTRS port for PUSCH transmissions to a first TRP based on a value of a most significant bit, MSB, of the PTRS-DMRS association field comprised in the DCI;
determining at least one DMRS port associated with at least one PTRS port for PUSCH transmissions to a second TRP based on a value of a least significant bit, LSB, of the PTRS-DMRS association field comprised in the DCI;
transmitting a first PUSCH repetition to the first TRP with the at least one PTRS port for PUSCH transmissions to the first TRP; and
transmitting a second PUSCH repetition to the second TRP with the at least one PTRS port for PUSCH transmissions to the first TRP;
wherein either:
the MSB of the PTRS-DMRS association field is associated with the first TRP and the LSB of the PTRS-DMRS association field is associated with the second TRP, where the first TRP is associated with a first Sounding Reference Signal, SRS, Resource Indicator, SRI, field in the DCI and the second TRP is associated with a second SRI field in the DCI; or
the MSB of the PTRS-DMRS association field is associated with a first SRS resource set associated to the first TRP and the LSB of the PTRS-DMRS association field is associated with a second SRS resource set associated to the second TRP, where the first SRS resource set is associated with the first SRI field in the DCI and the second SRS resource set is associated with the second SRI field in the DCI; or
the MSB of the PTRS-DMRS association field is associated with a first Transmit Precoding Matrix Indictor, TPMI, field of the DCI associated to the first TRP and the LSB of the PTRS-DMRS association field is associated with a second TPMI field of the DCI associated to the second TRP.

56. A method performed by a wireless communication device comprising:
receiving Downlink Control Information, DCI, from a base station, wherein:
the DCI schedules Physical Uplink Shared Channel, PUSCH, repetitions to two Transmission/Reception Points, TRPs; and
the DCI comprises:
an antenna ports field that indicates two or more Demodulation Reference Signal, DMRS, ports; and
a first Phase Tracking Reference Signal to Demodulation Reference Signal, PTRS-DMRS, association field and a second PTRS-DMRS association field, each being a 2-bit field;
determining at least one DMRS port associated with at least one PTRS port for PUSCH transmissions to a first TRP based on a value of at least one PTRS-DMRS association field comprised in the DCI;
determining at least one DMRS port associated with at least one PTRS port for PUSCH transmissions to a second TRP based on the value of the at least one PTRS-DMRS association field comprised in the DCI;
transmitting a first PUSCH repetition to the first TRP with the at least one PTRS port for PUSCH transmissions to the first TRP; and
transmitting a second PUSCH repetition to the second TRP with the at least one PTRS port for PUSCH transmissions to the second TRP;
wherein either:
a maximum rank is 4, the first PTRS-DMRS association field is associated with a first Sounding Reference Signal, SRS, resource set that is associated to the first TRP, and the second PTRS-DMRS association field is associated with a second SRS resource set that is associated to the second TRP; or
the first PTRS-DMRS association field is associated with a first Transmit Precoding Matrix Indictor, TPMI, field in the DCI that is associated to the first TRP, and the second PTRS-DMRS association field is associated with a second TPMI field in the DCI that is associated to the second TRP; or
two PT-RS ports per TRP are configured, the maximum rank is 4, the first PTRS-DMRS association field is associated with the first SRS resource set, the second PTRS-DMRS association field is associated with the second SRS resource set, the first SRS resource set is associated with a first SRS Resource Indicator, SRI, field in the DCI associated to the first TRP, and the second SRS resource set is associated with a second SRI field in the DCI associated to the second TRP.

57. The method of claim 56, wherein the maximum rank is 4, the first PTRS-DMRS association field is associated with the first SRS resource set that is associated to the first TRP, and the second PTRS-DMRS association field is associated with the second SRS resource set that is associated to the second TRP.

58. The method of claim 56, wherein the first PTRS-DMRS association field is associated with the first TPMI field in the DCI that is associated to the first TRP, and the second PTRS-DMRS association field is associated with the second TPMI field in the DCI that is associated to the second TRP.

59. The method of claim 56, wherein two PT-RS ports per TRP are configured, the maximum rank is 4, the first PTRS-DMRS association field is associated with the first SRS resource set, the second PTRS-DMRS association field is associated with the second SRS resource set, the first SRS resource set is associated with the first SRI field in the DCI associated to the first TRP, and the second SRS resource set is associated with the second SRI field in the DCI associated to the second TRP.

60. The method of claim 56, wherein a PTRS to PUSCH power ratio is configured per TRP.

61. A wireless communication device comprising:
one or more transmitters;
one or more receivers; and
processing circuitry associated with the one or more transmitters and the one or more receivers, the processing circuitry configured to cause the wireless communication device to:
receive Downlink Control Information, DCI, from a base station, wherein:
the DCI schedules Physical Uplink Shared Channel, PUSCH, repetitions to two Transmission/Reception Points, TRPs; and
the DCI comprises:
an antenna ports field that indicates two or more Demodulation Reference Signal, DMRS, ports; and
a first Phase Tracking Reference Signal to Demodulation Reference Signal, PTRS-DMRS, association field and a second PTRS-DMRS association field, each being a 2-bit field;
determine at least one DMRS port associated with at least one PTRS port for PUSCH transmissions to a first TRP based on a value of at least one PTRS-DMRS association field comprised in the DCI;
determine at least one DMRS port associated with at least one PTRS port for PUSCH transmissions to a second TRP based on the value of the at least one PTRS-DMRS association field comprised in the DCI;
transmit a first PUSCH repetition to the first TRP with the at least one PTRS port for PUSCH transmissions to the first TRP; and
transmit a second PUSCH repetition to the second TRP with the at least one PTRS port for PUSCH transmissions to the first TRP;
wherein either:
a maximum rank is 4, the first PTRS-DMRS association field is associated with a first Sounding Reference Signal, SRS, resource set that is associated to the first TRP, and the second PTRS-DMRS association field is associated with a second SRS resource set that is associated to the second TRP; or
the first PTRS-DMRS association field is associated with a first Transmit Precoding Matrix Indicator, TPMI, field in the DCI that is associated to the first TRP, and the second PTRS-DMRS association field is associated with a second TPMI field in the DCI that is associated to the second TRP; or
two PT-RS ports per TRP are configured, the maximum rank is 4, the first PTRS-DMRS association field is associated with the first SRS resource set, the second PTRS-DMRS association field is associated with the second SRS resource set, the first SRS resource set is associated with a first SRS Resource Indicator, SRI, field in the DCI associated to the first TRP, and the second SRS resource set is associated with a second SRI field in the DCI associated to the second TRP.

62. A method performed by a base station comprising:
sending Downlink Control Information, DCI, to a wireless communication device, wherein:
the DCI schedules Physical Uplink Shared Channel, PUSCH, repetitions to two Transmission/Reception Points, TRPs; and
the DCI comprises:
an antenna ports field that indicates two or more Demodulation Reference Signal, DMRS, ports; and
a Phase Tracking Reference Signal to Demodulation Reference Signal, PTRS-DMRS, association field, the PTRS-DMRS association field being a 2-bit field;
wherein either:
a Most Significant Bit, MSB, of the PTRS-DMRS association field is associated with a first TRP and a Least Significant Bit, LSB, of the PTRS-DMRS association field is associated with a second TRP, where the first TRP is associated with a first Sounding Reference Signal, SRS, Resource Indicator, SRI, field in the DCI and the second TRP is associated with a second SRI field in the DCI; or
the MSB of the PTRS-DMRS association field is associated with a first SRS resource set associated to the first TRP and the LSB of the PTRS-DMRS association field is associated with a second SRS resource set associated to the second TRP, where the first SRS resource set is associated with the first SRI field in the DCI and the second SRS resource set is associated with the second SRI field in the DCI; or
the MSB of the PTRS-DMRS association field is associated with a first Transmit Precoding Matrix Indictor, TPMI, field of the DCI associated to the first TRP and the LSB of the PTRS-DMRS association field is associated with a second TPMI field of the DCI associated to the second TRP.

63. A base station comprising processing circuitry configured to cause the base station to:
send Downlink Control Information, DCI, to a wireless communication device, wherein:
the DCI schedules Physical Uplink Shared Channel, PUSCH, repetitions to two Transmission/Reception Points, TRPs; and
the DCI comprises:
an antenna ports field that indicates two or more Demodulation Reference Signal, DMRS, ports; and
a Phase Tracking Reference Signal to Demodulation Reference Signal, PTRS-DMRS, association field, the PTRS-DMRS association field being a 2-bit field;
wherein either:
a Most Significant Bit, MSB, of the PTRS-DMRS association field is associated with a first TRP and a Least Significant Bit, LSB, of the PTRS-DMRS association field is associated with a second TRP, where the first TRP is associated with a first Sounding Reference Signal, SRS, Resource Indicator, SRI, field in the DCI and the second TRP is associated with a second SRI field in the DCI; or
the MSB of the PTRS-DMRS association field is associated with a first SRS resource set associated to the first TRP and the LSB of the PTRS-DMRS association field is associated with a second SRS resource set associated to the second TRP, where the first SRS resource set is associated with the first SRI field in the DCI and the second SRS resource set is associated with the second SRI field in the DCI; or
the MSB of the PTRS-DMRS association field is associated with a first Transmit Precoding Matrix Indictor, TPMI, field of the DCI associated to the first TRP and the LSB of the PTRS-DMRS association field is associated with a second TPMI field of the DCI associated to the second TRP.

64. A method performed by a base station comprising:
receiving Downlink Control Information, DCI, to a wireless communication device, wherein:
the DCI schedules Physical Uplink Shared Channel, PUSCH, repetitions to two Transmission/Reception Points, TRPs; and
the DCI comprises:
an antenna ports field that indicates two or more Demodulation Reference Signal, DMRS, ports; and
a first Phase Tracking Reference Signal to Demodulation Reference Signal, PTRS-DMRS, association field and a second PTRS-DMRS association field, each being a 2-bit field;
wherein either:
a maximum rank is 4, the first PTRS-DMRS association field is associated with a first Sounding Reference Signal, SRS, resource set that is associated to a first TRP, and the second PTRS-DMRS association field is associated with a second SRS resource set that is associated to a second TRP; or
the first PTRS-DMRS association field is associated with a first Transmit Precoding Matrix Indicator, TPMI, field in the DCI that is associated to the first TRP, and the second PTRS-DMRS association field is associated with a second TPMI field in the DCI that is associated to the second TRP; or
two PT-RS ports per TRP are configured, the maximum rank is 4, the first PTRS-DMRS association field is associated with the first SRS resource set, the second PTRS-DMRS association field is associated with the second SRS resource set, the first SRS resource set is associated with a first SRS Resource Indicator, SRI, field in the DCI associated to the first TRP, and the second SRS resource set is associated with a second SRI field in the DCI associated to the second TRP.

65. A base station comprising processing circuitry configured to cause the base station to:
receive Downlink Control Information, DCI, to a wireless communication device, wherein:
the DCI schedules Physical Uplink Shared Channel, PUSCH, repetitions to two Transmission/Reception Points, TRPs; and
the DCI comprises:
an antenna ports field that indicates two or more Demodulation Reference Signal, DMRS, ports; and
a first Phase Tracking Reference Signal to Demodulation Reference Signal, PTRS-DMRS, association field and a second PTRS-DMRS association field, each being a 2-bit field;
wherein either:
a maximum rank is 4, the first PTRS-DMRS association field is associated with a first Sounding Reference Signal, SRS, resource set that is associated to a first TRP, and the second PTRS-DMRS association field is associated with a second SRS resource set that is associated to a second TRP; or
the first PTRS-DMRS association field is associated with a first Transmit Precoding Matrix Indicator, TPMI, field in the DCI that is associated to the first TRP, and the second PTRS-DMRS association field is associated with a second TPMI field in the DCI that is associated to the second TRP; or
two PT-RS ports per TRP are configured, the maximum rank is 4, the first PTRS-DMRS association field is associated with the first SRS resource set, the second PTRS-DMRS association field is associated with the second SRS resource set, the first SRS resource set is associated with a first SRS Resource Indicator, SRI, field in the DCI associated to the first TRP, and the second SRS resource set is associated with a second SRI field in the DCI associated to the second TRP.
